(19) United States
(12) Patent Application Publication
(10) Pub. No.: US 2026/0314664 A1
(43) Pub. Date: Oct. 15, 2026

(54) AEROSOL-GENERATING DEVICE COMPRISING A SET OF AIRFLOW-REGULATING VALVES

(71) Applicant: Philip Morris Products S.A., Neuchatel (CH)

(72) Inventors: Rui Nuno Rodrigues Alves BATISTA, Morges (CH); Ugo Leonardo ORTOLINI, Vevey (CH)

(73) Assignee: Philip Morris Products S.A., Neuchatel (CH)

(21) Appl. No.: 19/485,958

(22) PCT Filed: May 13, 2024
(86) PCT No.: PCT/EP2024/063048

§ 371 Date: Nov. 19, 2025

(30) Foreign Application Priority Data
May 22, 2023 (EP) 23174652

(51) Int. Cl. A24F 40/30; A24F 40/20; A24F 40/465; A24F 40/485; H05B 6/10; H05B 6/36; H05B 6/44

(52) U.S. Cl. CPC A24F 40/30; A24F 40/20; A24F 40/465; A24F 40/485; H05B 6/105; H05B 6/362; H05B 6/44

(57) ABSTRACT

An aerosol-generating device is provided, including: a first cavity to receive a first aerosol-generating article including a first aerosol-forming substrate; a second cavity to receive a second aerosol-generating article including a second aerosol-forming substrate; an air inlet; a first cavity inlet between the air inlet and the first cavity; a first inlet valve movable between closed and open positions, the first inlet valve is biased towards the closed position in the absence of the first article being fully inserted into the first cavity, and the first inlet valve is in the open position when the first article is fully inserted in the first cavity; a second cavity inlet arranged between the air inlet and the second cavity; a second inlet valve movable between closed and open positions; and a heating arrangement including first and second heating elements.

The present invention relates to an aerosol-generating device and an aerosol-generating system.

It is known to provide an aerosol-generating device for generating an inhalable vapor. Such devices may heat aerosol-forming substrate to a temperature at which one or more components of the aerosol-forming substrate are volatilized without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to provide an aerosol-generating system providing improved heating efficiency. It would be desirable to provide an aerosol-generating system providing improved aerosol generation. It would be desirable to provide an aerosol-generating system providing an improved airflow through the system. It would be desirable to provide an aerosol-generating system enabling improved airflow control. It would be desirable to provide an aerosol-generating system providing an improved aerosol delivery. It would be desirable to provide an aerosol-generating device enabling use of multiple aerosol-forming substrates. It would be desirable to provide an aerosol-generating system enabling tailoring the provided user experience to the individual preferences of the consumer.

According to a first aspect of the invention there is provided an aerosol-generating device. The device comprises a first cavity configured for receiving a first aerosol-generating article comprising a first aerosol-forming substrate. The device comprises a second cavity configured for receiving a second aerosol-generating article comprising a second aerosol-forming substrate. The device comprises an air inlet. The device comprises a first cavity inlet arranged between the air inlet and the first cavity. The device comprises a first inlet valve. The first inlet valve is configured to be movable between a closed position and an open position. In the closed position, the air inlet and the first cavity are fluidly disconnected. In the open position, the first cavity is fluidly connected with the air inlet via the first cavity inlet. The first inlet valve comprises a first biasing means configured for biasing the first inlet valve towards the closed position in the absence of the first aerosol-generating article being fully inserted into the first cavity. The first inlet valve is configured to be in the open position when the first aerosol-forming element is fully inserted in the first cavity.

The device comprises a second cavity inlet arranged between the air inlet and the second cavity. The device comprises a second inlet valve. The second inlet valve is configured to be movable between a closed position and an open position. In the closed position, the air inlet and the second cavity are fluidly disconnected. In the open position, the second cavity is fluidly connected with the air inlet via the second cavity inlet. The second inlet valve comprises a second biasing means configured for biasing the second inlet valve towards the closed position in the absence of the second aerosol-generating article being fully inserted into the second cavity. The second inlet valve is configured to be in the open position when the second aerosol-forming element is fully inserted in the second cavity.

According to an embodiment of the invention, there is provided an aerosol-generating device. The device may comprise a first cavity configured for receiving a first aerosol-generating article comprising a first aerosol-forming substrate. The device may comprise a second cavity configured for receiving a second aerosol-generating article comprising a second aerosol-forming substrate. The device may comprise an air inlet. The device may comprise a first cavity inlet arranged between the air inlet and the first cavity. The device may comprise a first inlet valve. The first inlet valve may be configured to be movable between a closed position and an open position. In the closed position, the air inlet and the first cavity may be fluidly disconnected. In the open position, the first cavity may be fluidly connected with the air inlet via the first cavity inlet. The first inlet valve may comprise a first biasing means configured for biasing the first inlet valve towards the closed position in the absence of the first aerosol-generating article being fully inserted into the first cavity. The first inlet valve may be configured to be in the open position when the first aerosol-forming element is fully inserted in the first cavity,

The device may comprise a second cavity inlet arranged between the air inlet and the second cavity. The device may comprise a second inlet valve. The second inlet valve may be configured to be movable between a closed position and an open position. In the closed position, the air inlet and the second cavity may be fluidly disconnected. In the open position, the second cavity may be fluidly connected with the air inlet via the second cavity inlet. The second inlet valve may comprise a second biasing means configured for biasing the second inlet valve towards the closed position in the absence of the second aerosol-generating article being fully inserted into the second cavity. The second inlet valve may be configured to be in the open position when the second aerosol-forming element is fully inserted in the second cavity.

The aerosol-generating device may heat the aerosol-forming substrate with improved efficiency. The aerosol-generating device may provide improved airflow. The aerosol-generating device may provide improved aerosol flow. The aerosol-generating device may provide improved resistance to draw (RTD). The aerosol-generating device may provide improved aerosol generation. The aerosol-generating device may provide an improved user experience. The aerosol-generating device may provide improved airflow characteristics. The aerosol-generating device may provide improved mixing of external air and volatized aerosol-forming substrate. The aerosol-generating device may provide an aerosol of improved homogeneity. The aerosol-generating system may provide a more convenient handling for the user. The aerosol-generating system may provide improved adjustment of the user experience to the individual preferences of the user. The aerosol-generating system may provide a flexible user experience.

The first cavity may be cuboid-shaped. The first cavity may have a rectangular cross-section. The first cavity may be planar. The first cavity may be flat. The first cavity may be configured to closely match the shape of the first aerosol-forming substrate. The first cavity may be configured to closely match the shape of the first aerosol-generating article. The first cavity may be configured to slidably receive the first aerosol-forming substrate. The first cavity may be configured to slidably receive the first aerosol-generating article.

The second cavity may be cuboid-shaped. The second cavity may have a rectangular cross-section. The second cavity may be planar. The second cavity may be flat. The second cavity may be configured to closely match the shape of the second aerosol-forming substrate. The second cavity may be configured to closely match the shape of the second aerosol-generating article. The second cavity may be configured to slidably receive the second aerosol-forming substrate. The second cavity may be configured to slidably receive the second aerosol-generating article.

The first cavity inlet may be configured as a channel. The second cavity inlet may be configured as a channel.

The shape of the first cavity and the shape of the second cavity may be the same. Alternatively, the shape of the first cavity and the shape of the second cavity may be different.

The first cavity may comprise an open end. The first cavity open end may be arranged at the downstream end of the first cavity. The second cavity may comprise an open end. The second cavity open end may be arranged at the downstream end of the second cavity. The first cavity open end may be a proximal end. The second cavity open end may be a proximal end.

The first aerosol-generating article may be inserted into the first cavity via the first cavity open end. The second aerosol-generating article may be inserted into the second cavity via the second cavity open end.

The first cavity may comprise a base opposite to the first cavity open end. The second cavity may comprise a base opposite to the second cavity open end. The first cavity base may be closed except for the provision of the first cavity inlet arranged at the base. The second cavity base may be closed except for the provision of the second cavity inlet arranged at the base. The first cavity base may be flat. The second cavity base may be flat. The first cavity base may be rectangular. The second cavity base may be rectangular. The first cavity base may be arranged upstream of the first cavity. The second cavity base may be arranged upstream of the second cavity. The first cavity open end may be arranged downstream of the first cavity. The second cavity open end may be arranged downstream of the second cavity.

The first cavity may have an elongate extension. The second cavity may have an elongate extension. The first cavity may have a longitudinal central axis. The second cavity may have a longitudinal central axis. A longitudinal direction may be the direction extending between the base and the open end along the longitudinal central axis. The longitudinal central axis of the first cavity may be parallel to the longitudinal axis of the aerosol-generating device. The longitudinal central axis of the second cavity may be parallel to the longitudinal axis of the aerosol-generating device.

The first cavity inlet may be arranged distal to the first cavity. The first cavity may be arranged downstream of the first cavity inlet. The first cavity inlet may be configured to abut the first cavity. The first cavity inlet may be configured to abut an upstream end of the first cavity. The first cavity inlet may be arranged in a base of the first cavity.

The second cavity inlet may be arranged distal to the second cavity. The second cavity may be arranged downstream of the second cavity inlet. The second cavity inlet may be configured to abut the second cavity. The second cavity inlet may be configured to abut an upstream end of the second cavity. The second cavity inlet may be arranged in a base of the second cavity.

The first inlet valve may control an airflow through the first cavity. In the closed position, the first inlet valve may block an airflow through the first cavity inlet. In the closed position, the first inlet valve may block an airflow from the air inlet to the first cavity via the first cavity inlet. In the open position, the first inlet valve may allow an airflow through the first cavity inlet. In the open position, the first inlet valve may allow an airflow from the air inlet to the first cavity by the first cavity inlet.

The second inlet valve may control an airflow through the second cavity. In the closed position, the second inlet valve may block an airflow through the second cavity inlet. In the closed position, the second inlet valve may block an airflow from the air inlet to the second cavity via the second cavity inlet. In the open position, the second inlet valve may allow an airflow through the second cavity inlet. In the open position the second inlet valve may allow an airflow from the air inlet to the second cavity via the second cavity inlet.

The first biasing means may hold the first inlet valve in the closed position in the absence of the aerosol-generating article in the first cavity. By providing the first biasing means, airflow from the air inlet to the first cavity may be blocked in the absence of one or both of the aerosol-forming substrate and the aerosol-generating article in the first cavity.

The second biasing means may hold the second inlet valve in the closed position in the absence of the aerosol-generating article in the second cavity. By providing the second biasing means, airflow from the air inlet to the second cavity may be blocked in the absence of one or both of an aerosol-forming substrate and aerosol-generating article in the second cavity.

The first inlet valve may be at least partially arranged within the first cavity inlet. The second inlet valve may be at least partially arranged within the second cavity inlet.

The device may comprise a first airflow channel. The device may comprise a first airflow channel inlet arranged between the air inlet and the first airflow channel. The first airflow channel may be planar.

The first airflow channel may be cuboid-shaped. The first airflow channel may have a rectangular cross-section. The first airflow channel may be planar. The first airflow channel may be flat.

The first airflow channel may be arranged on the central longitudinal axis of the device.

The first cavity may be arranged radially outward of the first airflow channel. The second cavity may be arranged radially outward of the first airflow channel. The first airflow channel may be arranged between the first cavity and the second cavity.

The first airflow channel inlet may be arranged distal to the first airflow channel. The first airflow channel may be arranged downstream of the first airflow channel inlet. The first airflow channel inlet may be configured to abut the first airflow channel. The first airflow channel inlet may be configured to abut an upstream end of the first airflow channel. The first airflow channel inlet may be arranged in a base of the first airflow channel.

The first airflow channel may comprise an open end. The first airflow channel open end may be arranged at the downstream end of the first airflow channel.

The first airflow channel inlet may be configured as a channel.

The device may comprise an edge distribution channel. The distribution channel may be arranged between the air inlet and one or more of the first cavity inlet, the second cavity inlet and the first airflow channel. One or more of the first cavity inlet, the second cavity inlet and the first airflow channel may be fluidly connected to the air inlet via the air distribution channel if the corresponding inlet valves are open.

The device may comprise a third inlet valve configured for adjusting an airflow between the air inlet and the first airflow channel via the first airflow channel inlet.

The third inlet valve may be configured to be movable between a closed position and an open position. In the closed position, the air inlet and the first airflow channel may be fluidly disconnected. In the open position, the first airflow channel may be fluidly connected with the air inlet via the first airflow channel inlet.

The third inlet valve may comprise a third biasing means configured for biasing the third inlet valve towards the closed position.

The third inlet valve may control an airflow through the first airflow channel. In the closed position, the third inlet valve may at least partially block an airflow through the first airflow channel. In the closed position, the third inlet valve may at least partially block an airflow from the air inlet to the first airflow channel via the third cavity inlet. In the open position, the third inlet valve may allow an airflow through the first airflow channel inlet. In the open position, the third inlet valve may allow an airflow from the air inlet to the first airflow channel by the first airflow channel inlet. The position of the fourth inlet valve may be gradually adjusted.

The third biasing means may hold the third inlet valve in the closed position by default. The third biasing means may be an actuator, which biases the third inlet valve towards the closed position in the absence of an external stimulus.

The third inlet valve may be at least partially arranged within the first airflow channel inlet.

The third inlet valve may be an electronically controlled valve. The third inlet valve may be an electronically actuated valve. The third inlet valve may be moved between the closed position and the open position in response to the provision of an electrical signal.

The device may comprise at least one electromagnet arranged at a proximal end of the first airflow channel inlet. The device may be configured such that the airflow between the air inlet and the first airflow channel via the first airflow channel inlet is adjusted by controlling a magnetic interaction between the electromagnet and the third inlet valve.

The at least one electromagnet may be arranged in the base of the first airflow channel. The at least one electromagnet may surround at least a portion of the first airflow channel inlet. The at least one electromagnet may surround a downstream end of the first airflow channel inlet. The at least one electronic magnet may be arranged at a downstream end of the first airflow channel.

One or more of the first biasing means, second biasing means and the third biasing means may comprise a spring. The spring may be coil spring.

The first biasing means may comprise a first spring. The first spring may be a first coil spring. The second biasing means may comprise a second spring. The second spring may be a second coil spring. The third biasing means may comprise a third spring. The third

One or both, the first biasing means may be arranged proximal to the first cavity inlet and the second biasing means may be arranged proximal to the second cavity inlet.

The first biasing means may be arranged proximal to the first cavity inlet. The second biasing means may be arranged proximal to the second cavity inlet. The third biasing means may be arranged proximal to the first airflow channel inlet.

The first biasing means may be arranged abutting the base of the first cavity. The first biasing means may be arranged in contact with the base of the first cavity. The first biasing means may be arranged adjacent to the downstream end of the first cavity inlet.

The second biasing means may be arranged abutting the base of the second cavity. The second biasing means may be arranged in contact with the base of the second cavity. The second biasing means may be arranged adjacent to the downstream end of the second cavity inlet.

The third biasing means may be arranged abutting the base of the first airflow channel. The third biasing means may be arranged in contact with the base of the first airflow channel. The third biasing means may be arranged adjacent to the downstream end of the first airflow channel inlet.

One or both of the first inlet valve and the second inlet valve may be configured as a spring valve.

The first inlet valve may be configured as a first spring valve. The second inlet valve may be configured as a second spring valve.

One or more of the first inlet valve, the second inlet valve and the third inlet valve may comprise a spring retaining means, a head and a shaft. The shaft may be arranged between the spring retaining means and the head. The spring retaining means may be configured as a disc. The head may be configured as a tapered head.

The first inlet valve may comprise a first spring retaining means, a first head and a first shaft. The second inlet valve may comprise a second spring retaining means, a second head and second shaft. The third inlet valve may comprise a third spring retaining means, a third head and a third shaft.

The first spring retaining means may be arranged in the first cavity. The first spring retaining means may be arranged at the downstream end of the first cavity inlet. A diameter of the first spring retaining means may be larger than a diameter of the first cavity inlet. The first shaft may at least be partially arranged in the first cavity inlet. The first head may be arranged in the air distribution channel. The first head may be arranged at an upstream end of the first cavity inlet. A diameter of the first head may be larger than a diameter of the first cavity inlet. The first spring retaining means and the first head may be connected by the first shaft. The first spring retaining means may be arranged proximal to the first shaft. The first proximal to the first head.

The second spring retaining means may be arranged in the second cavity. The second spring retaining means may be arranged at the downstream end of the second cavity inlet. A diameter of the second spring retaining means may be larger than a diameter of the second cavity inlet. The second shaft may at least be partially arranged in the second cavity inlet. The second head may be arranged in the air distribution channel. The second head may be arranged at an upstream end of the second cavity inlet. A diameter of the second head may be larger than a diameter of the second cavity inlet. The second spring retaining means and the second head may be connected by the second shaft. The second spring retaining means may be arranged proximal to the second shaft. The second shaft may be arranged proximal to the second head.

The third spring retaining means may be arranged in the first airflow channel. The third spring retaining means may be arranged at the downstream end of the first airflow channel inlet. A diameter of the third spring retaining means may be larger than a diameter of the first airflow channel inlet. The third shaft may at least be partially arranged in the first airflow channel inlet. The third head may be arranged in the air distribution channel. A diameter of the third head may be larger than a diameter of the first airflow channel inlet. The third spring retaining means and the third head may be connected by the third shaft. The third spring retaining means may be arranged proximal to the third shaft. The third shaft may be arranged proximal to the third head.

The biasing means may be configured abutting the spring retaining means. The spring may be configured abutting the spring retaining means.

The first biasing means may be configured abutting the first spring retaining means. The first spring of the first biasing means may be configured abutting the first spring retaining means. The first biasing means may be configured abutting the base of the first cavity. The first spring may be configured abutting the base of the first cavity.

The second biasing means may be configured abutting the second spring retaining means. The second spring of the second biasing means may be configured abutting the second spring retaining means. The second biasing means may be configured abutting the base of the second cavity. The second spring may be configured abutting the base of the second cavity.

The third biasing means may be configured abutting the third spring retaining means. The third spring of the third biasing means may be configured abutting the third spring retaining means. The third biasing means may be configured abutting the base of the first airflow channel. The third spring may be configured abutting the base of the first airflow channel.

The first spring may be arranged around the first shaft of the first inlet valve. The second spring may be arranged around the second shaft of the second inlet valve. The third spring may be arranged around the third shaft of third inlet valve.

The first spring may be arranged between the first spring retaining means and the first cavity inlet. The second spring may be arranged between the second spring retaining means and the second cavity inlet. The third spring may be arranged between the third spring retaining means and the first airflow channel inlet.

One or more of the first inlet valve, the second inlet valve and the third inlet valve may comprise a valve guide. The shaft of the valve may be arranged at least partially within the valve guide.

The valve guide of first inlet valve may be arranged at least partially within the first cavity inlet. The valve guide of second inlet valve may be arranged at least partially within the second cavity inlet. The valve guide of third inlet valve may be arranged at least partially within the first airflow channel inlet.

The valve guide may improve the precision of blocking airflow in the closed position. Usage of a valve guide may improve the smoothness of transition between the closed position and the open position.

When fully inserting the first aerosol-generating article into the first cavity, the article may be in contact with the first inlet valve. When fully inserting the first aerosol-generating article into the first cavity, the article may be in contact with the first spring retaining means. When fully inserting the first aerosol-generating article into the first cavity, the article may exert a force on the first inlet valve. The force may be exerted in a distal direction. When fully inserting the first aerosol-generating article into the first cavity, the article may exert a force on the first spring retaining means. The force may be exerted in a distal direction. When fully inserting the first aerosol-generating article to the first cavity, the article may push the first inlet valve in a distal direction. When fully inserting the first aerosol-generating article into the first cavity, the article may push the first spring retaining means towards the downstream end of the first cavity inlet. When fully inserting the first aerosol-generating article into the first cavity, the article may move the first inlet valve from the closed position to the open position. When fully inserting the first aerosol-generating article into the first cavity, the article may push the first inlet valve from the closed position to the open position. When fully inserting the first aerosol-generating article into the first cavity, the article may push the first head away from the distal end of the first cavity inlet. When fully inserting the first aerosol-generating article into the first cavity, the article may compress the first biasing means. When fully inserting the first aerosol-generating article into the first cavity, the article may compress the first spring of the first biasing means. When fully inserting the first aerosol-generating article to the first cavity, the article may compress the first spring between the first spring retaining means and a base of the first cavity. The fully inserted first aerosol-generating article may hold the first inlet valve in the open position.

The first biasing means may exert a force on first aerosol-generating article. The first biasing means my exerted a force on the first aerosol-generating article in a proximal direction. The first biasing means may push the first aerosol-generating article in a proximal direction. The first biasing means may be configured to eject the first aerosol-generating article. The first biasing means may be configured to eject the fully inserted first aerosol-generating article. The first inlet valve may be configured to eject the fully inserted first aerosol-generating article. The first inlet valve may eject the inserted first aerosol-generating article after a user experience has been provided. The first inlet valve may eject the inserted first aerosol-generating article when the user desires removal of the first aerosol-generating article. The first inlet valve may eject the inserted first aerosol-generating article after the first aerosol-forming substrate has been depleted. Ejection of the first aerosol-generating article by the first inlet valve may improve the convenience of handling of the aerosol generating system for the user. The user may more easily remove the ejected first aerosol-generating article.

When fully inserting the second aerosol-generating article into the second cavity, the article may be in contact with the second inlet valve. When fully inserting the second aerosol-generating article into the second cavity, the article may be in contact with the second spring retaining means. When fully inserting the second aerosol-generating article into the second cavity, the article may exert a force on the second inlet valve. The force may be exerted in a distal direction. When fully inserting the second aerosol-generating article into the second cavity, the article may exert a force on the second spring retaining means. The force may be exerted in a distal direction. When fully inserting the second aerosol-generating article to the second cavity, the article may push the second inlet valve in a distal direction. When fully inserting the second aerosol-generating article into the second cavity, the article may push the second spring retaining means towards the downstream end of the second cavity inlet. When fully inserting the second aerosol-generating article into the second cavity, the article may move the second inlet valve from the closed position to the open position. When fully inserting the second aerosol-generating article into the second cavity, the article may push the second inlet valve from the closed position to the open position. When fully inserting the second aerosol-generating article into the second cavity, the article may push the second head away from the distal end of the second cavity inlet. When fully inserting the second aerosol-generating article into the second cavity, the article may compress the second biasing means. When fully inserting the second aerosol-generating article into the second cavity, the article may compress the second spring of the second biasing means. When fully inserting the second aerosol-generating article to the second cavity, the article may compress the second spring between the second spring retaining means and a base of the second cavity. The fully inserted second aerosol-generating article may hold the second inlet valve in the open position.

The second biasing means may exert a force on second aerosol-generating article. The second biasing means my exerted a force on the second aerosol-generating article in a proximal direction. The second biasing means may push the second aerosol-generating article in a proximal direction. The second biasing means may be configured to eject the second aerosol-generating article. The second biasing means may be configured to eject the fully inserted second aerosol-generating article. The second inlet valve may be configured to eject the fully inserted second aerosol-generating article. The second inlet valve may eject the inserted second aerosol-generating article after a user experience has been provided. The second inlet valve may eject the inserted second aerosol-generating article when the user desires removal of the second aerosol-generating article. The second inlet valve may eject the inserted second aerosol-generating article after the second aerosol-forming substrate has been depleted. Ejection of the second aerosol-generating article by the second inlet valve may improve the convenience of handling of the aerosol generating system for the user. The user may more easily remove the ejected second aerosol-generating article.

The device may comprise a heating arrangement. The heating arrangement may comprise a first heating element and a second heating element. The first heating element may be configured abutting the first cavity. The second heating element may be configured abutting the second cavity. One or both of the first heating element and the second heating element may be planar.

The first heating element may be cuboid-shaped. The first heating element may have a rectangular cross-section. The first heating element may be planar. The first heating element may be flat. The first heating element may be a sheet. The first heating element may be of perforated sheet. The first heating element may comprise perforations. The first heating element may comprise angled perforations.

The second heating element may be cuboid-shaped. The second heating element may have a rectangular cross-section. The second heating element may be planar. The second heating elements may be flat. The second heating element may be a sheet. The second heating element may be a perforated sheet. The second heating element may comprise perforations. The second heating element may comprise angled perforations.

The first heating element may be configured to heat the first aerosol-forming substrate to volatize at least a portion of the first aerosol-forming substrate. The second heating element may be configured to heat the second aerosol-forming substrate to volatize at least a portion of the second aerosol-forming substrate.

The first heating element may be arranged between the first cavity and the first airflow channel. The second heating element may be arranged between the second cavity and the first airflow channel. The first heating element may be arranged abutting the first airflow channel. The second heating element may be arranged abutting the first airflow channel.

The first heating element may align the first airflow channel. The second heating element may align the first airflow channel. The first heating element may align the first cavity. The second heating element may align the second cavity. The first heating element may be arranged radially outward of the first airflow channel. The second heating element may be arranged radially outward of the first airflow channel. The first cavity may be arranged radially outward of the first heating element. The second cavity may be arranged radially outward of the second heating element. The first heating element may be in contact with the first cavity. The second heating element may be in contact with the second cavity. The first heating element may be in contact with the inserted first aerosol-generating article. The second heating element may be in contact with the inserted second aerosol-generating article.

One or both of the first heating element and the second heating element may each comprise one or more perforations.

The first heating element may be configured for fluidly connecting the first cavity with the first airflow channel via the one or more perforations of the first heating element. The second heating element may be configured for fluidly connecting the second cavity with the first airflow channel via the one or more perforations of the second heating element.

The first heating element may be a resistive heating element. The second heating element may be a resistive heating element.

The first heating element may be configured to heat the first aerosol-forming substrate of the first aerosol-generating article inserted into the first cavity. The second heating element may be configured to heat the second aerosol-forming substrate of the second aerosol-generating article inserted into the first cavity. Alternatively, the second heating element may be configured to heat the first aerosol-forming substrate of the first aerosol-generating article inserted into the first cavity.

The device may comprise a second airflow channel. The device may comprise a second airflow channel inlet arranged between the air inlet and the second airflow channel. The second airflow channel may be planar.

The device may comprise a fourth inlet valve configured for adjusting an airflow between the air inlet and the second airflow channel via the second airflow channel inlet.

The fourth inlet valve may be configured to be movable between a closed position and an open position. In the closed position, the air inlet and the second airflow channel may be fluidly disconnected. In the open position, the second airflow channel may be fluidly connected with the air inlet via the second airflow channel inlet.

The fourth inlet valve may be at least partially arranged within the second airflow channel inlet.

The fourth inlet valve may be an electronically controlled valve.

The device may comprise at least one electromagnet arranged at a proximal end of the second airflow channel inlet. The device may be configured such that the airflow between the air inlet and the second airflow channel via the second airflow channel inlet is adjusted by controlling a magnetic interaction between the electromagnet and the third inlet valve.

The second airflow channel may be cuboid-shaped. The second airflow channel may have a rectangular cross-section. The second airflow channel may be planar. The second airflow channel may be flat.

The second airflow channel may comprise an open end. The second airflow channel open end may be arranged at the downstream end of the second airflow channel.

The first airflow channel may comprise a base opposite to the first airflow channel open end. The second airflow channel may comprise a base opposite to the second airflow channel open end. The first airflow channel base may be closed except for the provision of the first airflow channel inlet arranged at the base. The second airflow channel base may be closed except for the provision of the second airflow channel inlet arranged at the base. The first airflow channel base may be flat. The second airflow channel base may be flat. The first airflow channel base may be rectangular. The second airflow channel base may be rectangular. The first airflow channel base may be arranged upstream of the first airflow channel. The second airflow channel base may be arranged upstream of the second airflow channel. The first airflow channel open end may be arranged downstream of the first airflow channel. The second airflow channel open end may be arranged downstream of the second airflow channel.

The first airflow channel may have an elongate extension. The second airflow channel may have an elongate extension. The first airflow channel may have a longitudinal central axis. The second airflow channel may have a longitudinal central axis.

The second airflow channel inlet may be arranged distal to the second airflow channel. The second airflow channel may be arranged downstream of the second airflow channel inlet. The second airflow channel inlet may be configured to abut the second airflow channel. The second airflow channel inlet may be configured to abut an upstream end of the second airflow channel. The second airflow channel inlet may be arranged in a base of the second airflow channel.

The second airflow channel inlet may be configured as a channel.

The distribution channel may be arranged between the air inlet and one or more of the first cavity inlet, the second cavity inlet, the first airflow channel and the second airflow channel. One or more of the first cavity inlet, the second cavity inlet, the first airflow channel and the second airflow channel may be fluidly connected to the air inlet via the air distribution channel if the corresponding inlet valves are open.

The fourth inlet valve may comprise a fourth biasing means configured for biasing the fourth inlet valve towards the closed position.

The fourth inlet valve may control an airflow through the second airflow channel. In the closed position, the fourth inlet valve may at least partially block an airflow through the second airflow channel. In the closed position, the fourth inlet valve may at least partially block an airflow from the air inlet to the second airflow channel via the fourth cavity inlet. In the open position, the fourth inlet valve may allow an airflow through the second airflow channel inlet. In the open position, the fourth inlet valve may allow an airflow from the air inlet to the second airflow channel by the second airflow channel inlet. The position of the fourth inlet valve may be gradually adjusted.

The fourth biasing means may hold the fourth inlet valve in the closed position by default. The fourth biasing means may be an actuator, which biases the fourth inlet valve towards the closed position in the absence of an external stimulus.

The fourth inlet valve may be an electronically actuated valve. The fourth inlet valve may be moved between the closed position and the open position in response to the provision of an electrical signal.

The device may comprise at least one electromagnet arranged at a proximal end of the second airflow channel inlet. The device may be configured such that the airflow between the air inlet and the second airflow channel via the second airflow channel inlet is adjusted by controlling a magnetic interaction between the electromagnet and fourth third inlet valve.

The at least one electromagnet may be arranged in the base of the second airflow channel. The at least one electromagnet may surround at least a portion of the second airflow channel inlet. The at least one electromagnet may surround a downstream end of the second airflow channel inlet. The at least one electronic magnet may be arranged at a downstream end of the second airflow channel.

The fourth biasing means may comprise a fourth spring. The fourth spring may be a fourth coil spring. The fourth biasing means may comprise a fourth spring. The fourth spring may be a fourth coil spring. The fourth biasing means may comprise a fourth spring. The fourth spring may be a fourth coil spring.

The fourth biasing means may be arranged proximal to the second airflow channel inlet.

The fourth biasing means may be arranged abutting the base of the second airflow channel. The fourth biasing means may be arranged in contact with the base of the second airflow channel. The fourth biasing means may be arranged adjacent to the downstream end of the second airflow channel inlet.

The fourth inlet valve may comprise fourth spring retaining means, a fourth shaft and fourth shaft. The fourth spring retaining means may be arranged in the second airflow channel. The fourth spring retaining means may be arranged at the downstream end of the second airflow channel inlet. A diameter of the fourth spring retaining means may be larger than a diameter of the second airflow channel inlet. The fourth shaft may at least be partially arranged in the second airflow channel inlet. The fourth head may be arranged in the air distribution channel. A diameter of the fourth head may be larger than a diameter of the second airflow channel inlet. The fourth spring retaining means and the fourth head may be connected by the fourth shaft. The fourth spring retaining means may be arranged proximal to the fourth shaft. The fourth shaft may be arranged proximal to the fourth head.

The fourth biasing means may be configured abutting the fourth spring retaining means. The fourth spring of the fourth biasing means may be configured abutting the fourth spring retaining means. The fourth biasing means may be configured abutting the base of the second airflow channel. The fourth spring may be configured abutting the base of the second airflow channel.

The fourth spring may be arranged around the fourth shaft of fourth inlet valve. The fourth spring may be arranged between the fourth spring retaining means and the second airflow channel inlet.

The fourth inlet valve may comprise a valve guide. The fourth shaft of the fourth inlet valve may be arranged at least partially within the valve guide of the fourth inlet valve. The valve guide of fourth inlet valve may be arranged at least partially within the second airflow channel inlet.

The first heating element may be configured abutting the first airflow channel. The second heating element may be configured abutting the second airflow channel. The first heating element may be configured for fluidly connecting the first cavity with the first airflow channel via the one or more perforations of the first heating element. The second heating element may be configured for fluidly connecting the second cavity with the second airflow channel via the one or more perforations of the second heating element.

The heating arrangement may comprise a first induction coil. The heating element may comprise a first planar induction coil.

The first induction coil may have a rectangular cross-section. The first induction coil may be flat. The first induction coil may be cuboid-shaped.

The first planar induction coil may be configured abutting the first cavity. The first planar induction coil may align the first cavity. The first planar induction coil may be arranged parallel to the first cavity. The first planar induction coil may be arranged parallel to the first heating element. The first planar induction coil may be parallel to the first airflow channel.

The first planar induction coil may comprise shielding. The shielding may be an electromagnetic shielding. The electromagnetic shielding may at least partially shield the rest of the device from an electromagnetic field produced by the first induction coil. The shielding may be thermal shielding. The thermal shielding may protect a user holding the device from being burnt by the heat produced by one or more of the first heating element and the second heating element.

The first heating element may be as susceptor. The first heating element may be a perforated susceptor. The first heating element may be a first induction heating element. The first heating element may be a first perforated induction heating element.

Power may be provided to the first planar induction coil. The first planar induction coil may be configured to heat the first heating element. The first planar induction coil may generate an alternating magnetic field penetrating the first heating element.

The first planar induction coil may be sealed. The first planar induction coil may be arranged in a device housing wall.

The first induction coil may be arranged abutting the first cavity and the second cavity.

The heating arrangement may comprise a second induction coil. The heating arrangement may comprise second planar induction coil.

The first induction coil may be arranged abutting the first cavity. The second induction coil may be arranged abutting the second cavity.

The second induction coil may have a rectangular cross-section. The second induction coil may be flat. The second induction coil may be cuboid-shaped.

The second planar induction coil may be configured abutting the second cavity. The second planar induction coil may align the second cavity. The second planar induction coil may be arranged parallel to the second cavity. The second planar induction coil may be arranged parallel to the second heating element. The second planar induction coil may be parallel to the first airflow channel.

The second planar induction coil may comprise shielding. The shielding may be an electromagnetic shielding. The electromagnetic shielding may at least partially shield the rest of the device from an electromagnetic field produced by the second induction coil. The shielding may be thermal shielding. The thermal shielding may protect a user holding the device from being burnt by the heat produced by one or more of the first heating element and

The second heating element may be as susceptor. The second heating element may be a perforated susceptor. The second heating element may be a second induction heating element. The second heating element may be a second perforated induction heating element.

Power may be provided to the second planar induction coil. The second planar induction coil may be configured to heat the second heating element. The second planar induction coil may generate an alternating magnetic field penetrating the second heating element.

The second planar induction coil may be sealed. The second planar induction coil may be arranged in a device housing wall.

The device may comprise a removable mouthpiece.

The device may comprise a main body comprising one or more of a controller and a power supply.

The mouthpiece may comprise a housing. The mouthpiece may be removably mountable to the device. The mouthpiece may be in fluidly connected with the first airflow channel via the first airflow channel open end. The mouthpiece may be fluidly connected with the second flow channel via the second airflow channel open end. The mouthpiece may be fluidly connected with the first cavity via the first cavity open end. The mouthpiece may be fluidly connected with the second cavity via the second cavity open end. The mouthpiece may comprise an aerosol outlet. The user may inhale aerosol through the aerosol outlet. The aerosol outlet may be fluidly connected with one or more of the first airflow channel, the second flow channel, the first cavity, and the second cavity.

The mouthpiece may comprise a chamber. The chamber may be fluidly connected with one or more of the first airflow channel, the second flow channel, the first cavity, and the second cavity. The chamber may be fluidly connected with one or more of the first airflow channel via the first airflow channel open end, the second flow channel via the second airflow channel open end, the first cavity via the first cavity open end, and the second cavity via the second cavity open end. The chamber may be fluidly connected with the aerosol outlet. Airflows from one or more of the first cavity, the second cavity, the first airflow channel, and the second airflow channel may mix in the chamber.

The mouthpiece may be arranged downstream of one or more of the first airflow channel, the second flow channel, the first cavity, and the second cavity. The mouthpiece may be arranged at the mouth end. The mouthpiece may be arranged at the downstream end of the device. The mouthpiece may be a hinged mouthpiece. The chamber may be cooling chamber. One or both of volatized first-aerosol forming substrate and second aerosol-forming substrate in an airflow entering the chamber may cool inside the chamber to form an aerosol. The chamber may be a mixing chamber. Airflow from one or more of the first cavity, the second cavity, the first airflow channel and the second airflow channel may mix in the chamber. A homogenised mixture may be obtained.

The device may comprise a main body. The main body may comprise a controller. The main body may comprise a power supply. The power supply may be a battery. The main body may comprise one or more of the heating arrangement, the first cavity, the second cavity, the first airflow channel and the second flow channel. Alternatively, one or more of the heating arrangement, the first cavity, the second cavity, the first airflow channel and the second airflow channel may be arranged an intermediate section. The main body may be configured to be removably mountable to the mouthpiece. The main body may comprise a housing.

The main body may comprise an interface. The interface may be configured as a data port for transferring data. The interface may be configured to connect to an external energy source for recharging the power supply.

The mouthpiece may be removed from the main body to insert one or both of the first aerosol-generating article and second aerosol-generating article.

The intermediate section may comprise a housing. The main body may be configured to be removably mounted to a downstream and of the intermediate section. The intermediate section may be configured to be removably mounted to an upstream end of the mouthpiece. The mouthpiece may be configured to be removably mounted to the downstream end of the intermediate section.

By providing the removably mountable mouthpiece, the removably mountable intermediate section and the removably mountable main body, the manufacturer may upgrade each part one at a time. By providing the removably mountable mouthpiece, the removably mountable intermediate section and the removably mountable main body, accessibility to one or both of the first cavity and the second cavity may be improved.

The main body may have a length of between 30 millimeters and 70 millimeters. The main body may have a width of between 12 millimeters and 35 millimeters. The main body may have a height of between 5 millimeters and 15 millimeters.

The intermediate section may have a length of between 20 millimeters and 45 millimeters. The intermediate section may have a width of between 12 millimeters and 35 millimeters. The intermediate section may have a height of between 5 millimeters and 15 millimeters.

The mouthpiece may have a length of between 15 millimeters and 40 millimeters. The mouthpiece may have width of between 12 millimeters and 35 millimeters. The mouthpiece may have a height of between 5 millimeters and 15 millimeters.

The first biasing means may be configured for exerting an ejecting force in a proximal aerosol-generating article.

The second biasing means may be configured for exerting an ejecting force in a proximal direction on the second aerosol-generating article.

The mouthpiece may be configured for exerting a force in a distal direction on the first aerosol-generating article inserted into the first cavity against the bias of the first biasing means, such that the first inlet valve is moved from the closed position to the open position.

The mouthpiece may be configured to hold the first aerosol-generating article fully inserted in the first cavity. The mouthpiece may be configured to counterbalance a force exerted by the first biasing means on the inserted first aerosol-generating article. The mouthpiece may be configured to hold the first inlet valve in the open position when it is mounted to the device and the first aerosol-generating article is inserted into the first cavity.

The mouthpiece may comprise a first pushing means. The first pushing means may comprise a first projection of the housing of the mouthpiece. The first pushing means may be configured to fully insert a partially first aerosol-generating article into the first cavity. The first pushing means may be configured to push an inserted first aerosol-generating article against the bias of the first biasing element. The first pushing means may be configured to move the first inlet valve from the closed position to the open position by pushing on a partially inserted first aerosol-generating article. The first pushing means may be configured to exert a force in a distal direction on the first aerosol-generating article inserted into the first cavity. The first pushing means may be configured to engage with a partially or fully inserted first aerosol-generating article. The first pushing means may be configured to engage with a partially or fully inserted first aerosol-generating article when the mouthpiece is mounted at one or both of the intermediate section and the main body. The first pushing means may be configured to exert a force on the fully inserted first aerosol-generating article, such that the first inlet valve is held in the open position. The first projection of the housing of the mouthpiece may be configured to engage with a fully or partially first inserted aerosol-forming substrate. The first projection of the housing the mouthpiece may be configured to engage with a fully or partially first inserted aerosol-generating article.

The first pushing means may be moved between a first position and a second position. In the first position, the mouthpiece may be at least partially detached from the device. In the first position, the first pushing means may be configured to be disengaged from the first aerosol-generating article. In the first position, the first inlet valve may be configured to be in the closed position.

In the second position, the mouthpiece may be fully attached to the device. In the second position, the mouthpiece may be configured to abut a proximal end of one of the intermediate section and the main body. In the second position, the first inlet valve may be configured to be in the open position. In the second position, the first pushing means may be configured to engage with the inserted aerosol-generating article. In the second position, the first pushing means may be configured to push on the first aerosol-generating article in a distal direction. In the second position, the first aerosol-generating article be configured to engage with the first inlet valve. In the second position, the first aerosol-generating article may be configured to push on the first inlet valve in a distal direction.

By moving the first pushing means from the first position into the second position, the first aerosol-generating article may be fully inserted into the first cavity. By moving the pushing means from the second position into the first position, the first aerosol-generating article may be ejected from the first cavity.

The mouthpiece may be configured for exerting a force in a distal direction on the second aerosol-generating article inserted into the second cavity against the bias of the second biasing means such that the second inlet valve is moved from the closed position into the open position.

The mouthpiece may be configured to hold the second aerosol-generating article fully inserted in the second cavity. The mouthpiece may be configured to counterbalance a force exerted by the second biasing means on the inserted second aerosol-generating article. The mouthpiece may be configured to hold the second inlet valve in the open position when it is mounted to the device and the second aerosol-generating article is inserted into the second cavity.

The mouthpiece may comprise a second pushing means. The second pushing means may comprise a second projection of the housing of the mouthpiece. The second pushing means may be configured to fully insert a partially second aerosol-generating article into the second cavity. The second pushing means may be configured to push an inserted second aerosol-generating article against the bias of the second biasing element. The second pushing means may be configured to move the second inlet valve from the closed position to the open position by pushing on a partially inserted second aerosol-generating article. The second pushing means may be configured to exert a force in a distal direction on the second aerosol-generating article inserted into the second cavity. The second pushing means may be configured to engage with a partially or fully inserted second aerosol-generating article. The second pushing means may be configured to engage with a partially or fully inserted second aerosol-generating article when the mouthpiece is mounted at one or both of the intermediate section and the main body. The second pushing means may be configured to exert a force on the fully inserted second aerosol-generating article, such that the second inlet valve is held in the open position. The second projection of the housing of the mouthpiece may be configured to engage with a fully or partially second inserted aerosol-forming substrate. The second projection of the housing the mouthpiece may be configured to engage with a fully or partially second inserted aerosol-generating article.

The second pushing means may be moved between a first position and a second position. In the first position, the mouthpiece may be at least partially detached from the device. In the first position, the second pushing means may be configured to be disengaged from the second aerosol-generating article. In the first position, the second inlet valve may be configured to be in the closed position.

In the second position, the mouthpiece may be fully attached to the device. In the second position, the mouthpiece may be configured to abut a proximal end of one of the intermediate section and the main body. In the second position, the second inlet valve may be configured to be in the open position. In the second position, the second pushing means may be configured to engage with the inserted aerosol-generating article. In the second position, the second pushing means may be configured to push on the second aerosol-generating article in a distal direction. In the second position, the second aerosol-generating article be configured to engage with the second inlet valve. In the second position, the second aerosol-generating article may be configured to push on the second inlet valve in a distal direction.

By moving the second pushing means from the first position into the second position, the second aerosol-generating article may be fully inserted into the second cavity. By moving the pushing means from the second position into the first position, the second aerosol-generating article may be ejected from the second cavity.

One or both of the first cavity and the second cavity may be planar.

The first aerosol-generating article may be inserted into the first cavity via the first cavity inlet. The second aerosol-generating article may be inserted into the second cavity via the second cavity inlet.

One or both of the first cavity and the second cavity may have a length of between 10 millimeters and 30 millimeters. One both of the first cavity and the second cavity may have a width of between 7 millimeters and 17 millimeters. One or both of first cavity in the second cavity may have a height of between 1 millimeter and 5 millimeters.

One or both of the first and the second airflow channel may have a length of between 7 millimeters and 21 millimeters. One or both of the first and the second airflow channel may have a width of between 7 millimeters and 17 millimeters. One or both of the first and the second airflow channel may have a height of between 1.5 millimeters and 3.5 millimeters.

The first induction coil may be arranged on the central longitudinal axis of the device. The first cavity may be configured to abut the first induction coil. The second cavity may be configured to abut the first induction coil. The first induction coil may be arranged between the first cavity and the second cavity. The first induction coil may be sandwiched between the first cavity and the second cavity.

The first heating element may be arranged abutting the first cavity. The first heating element may be in contact with the first cavity. The first heating element may be in contact with an aerosol-generating article inserted into the first cavity. The first heating element may be configured to heat the first aerosol-generating substrate. The second heating element may be arranged abutting the second cavity. The second heating element may be in contact with the second cavity. The second heating element may be in contact with an aerosol-generating article inserted into the second cavity. The second heating element may be configured to heat the second aerosol-generating substrate.

The first airflow channel may be arranged abutting the first heating element. The first heating element may be arranged between the first cavity and the first airflow channel. The second airflow channel may be arranged abutting the second heating element. The second heating element may be arranged between the second cavity and the second airflow channel.

The first airflow channel may be fluidly connected to the first cavity via the perforations of the first heating element. The second airflow channel may be fluidly connected to the second cavity via the perforations of the second heating element.

The first induction coil may be configured to heat the first heating element and the second heating element. The first induction coil may be configured to generate an alternating magnetic field penetrating the first heating element and the second heating element.

In an optional embodiment, the device may comprise may comprise a first cavity configured for receiving a first aerosol-generating article comprising a first aerosol-forming substrate. The device may comprise an air inlet. The device may comprise a first cavity inlet arranged between the air inlet and the first cavity. The device may comprise a first inlet valve. The first inlet valve may be configured to be movable between a closed position and an open position. In the closed position, the air inlet and the first cavity may be fluidly disconnected. In the open position, the first cavity may be fluidly connected with the air inlet via the first cavity inlet. The first inlet valve may comprise a first biasing means configured for biasing the first inlet valve towards the closed position in the absence of the first aerosol-generating article being fully inserted into the first cavity. The first inlet valve may be configured to be in the open position when the first aerosol-forming element is fully inserted in the first cavity. The optional embodiment may not comprise a second cavity.

The device may comprise the first resistive heating element and the second resistive heating element. The first cavity may be arranged between the first resistive heating element and the second resistive heating element. The first resistive heating element may be configured to abut the first cavity. The second resistive heating element may be configured to abut the first cavity. The first airflow channel may be configured to abut the first resistive heating element. The first airflow channel may be arranged radially outward of the first resistive heating element. The second airflow channel may be configured to abut this second resistive heating element. The second airflow channel may be arranged radially outward of the second resistive heating element.

In a second aspect of the invention, there is provided an aerosol-generating system comprising the aerosol-generating device as described herein and a first aerosol-generating article comprising a first aerosol-forming substrate. The system may comprise a first planar aerosol-generating article.

In an embodiment of the invention, there is provided an aerosol-generating system, which may comprise the aerosol-generating device as described herein and a first aerosol-generating article comprising a first aerosol-forming substrate.

One or both of the first aerosol-generating article and the first aerosol-forming substrate may be porous.

The first aerosol-generating article may be configured to allow an airflow through the first aerosol-generating article. The first aerosol-forming substrate may be configured to allow an airflow through the first aerosol-forming substrate.

As used herein, a “porous” element may be an element through which air can pass through when the pressure drop applied (resistance to draw) is in the range of between 80 to 130 mm H₂O.

The first aerosol-generating substrate may be a first planar aerosol-generating substrate.

A planar aerosol-generating article may be manufactured more efficiently. A planar aerosol-generating article may be compact. A planar aerosol-generating article may be heated with improved efficiency.

The first aerosol-generating article may be cuboid-shaped. The first aerosol-generating article may have a rectangular cross-section. The first aerosol-generating article may be flat. The first aerosol-generating article may be cylindrical. The first aerosol-generating article may have a flat cylindrical shape. The first aerosol-generating article may have an oval cross section. The first aerosol-generating article may be coin-shaped.

The first aerosol-forming substrate may be cuboid-shaped. The first aerosol-forming substrate may have a rectangular cross-section. The first aerosol-forming substrate may be flat. The first aerosol-forming substrate may be cylindrical. The first aerosol-forming substrate may have a flat cylindrical shape. The first aerosol-forming substrate may have an oval cross section. The first aerosol-forming substrate may be coin-shaped.

The first aerosol-generating article may be configured to be slidable into the first cavity.

The system may comprise a second aerosol-generating article comprising a second aerosol-forming substrate. The system may comprise a second planar aerosol-generating article.

One or both of the second aerosol-generating article and the second aerosol-forming substrate may be porous.

The second aerosol-generating article may be configured to allow an airflow through the second aerosol-generating article. The second aerosol-forming substrate may be configured to allow an airflow through the second aerosol-forming substrate.

The second aerosol-generating article may be cuboid-shaped. The second aerosol-generating article may have a rectangular cross-section. The second aerosol-generating article may be flat. The second aerosol-generating article may be cylindrical. The second aerosol-generating article may have a flat cylindrical shape. The second aerosol-generating article may have an oval cross section. The second aerosol-generating article may be coin-shaped.

The second aerosol-forming substrate may be cuboid-shaped. The second aerosol-forming substrate may have a rectangular cross-section. The second aerosol-forming substrate may be flat. The second aerosol-forming substrate may be cylindrical. The second aerosol-forming substrate may have a flat cylindrical shape. The second aerosol-forming substrate may have an oval cross section. The second aerosol-forming substrate may be coin-shaped.

The second aerosol-generating article may be configured to be slidable into the second cavity.

The first aerosol-forming substrate may be configured to be different from the second aerosol-forming substrate. The first aerosol-generating article may be configured to be different from the second aerosol-generating article.

The first aerosol-forming substrate may be configured to be the same as the second aerosol-forming substrate. The first aerosol-generating article may be configured to be the same as the second aerosol-generating article.

The first aerosol-generating article may be shaped to closely conform to the shape of the first cavity. The second aerosol-generating article may be shaped to closely conform to the shape of the second cavity.

One or both of the first aerosol-forming substrate and the first aerosol-generating article may be configured to move the first inlet valve from the closed position into the open position.

One or both of the second aerosol-forming substrate and the second aerosol-generating article may be configured to move the second inlet valve from the closed position into the open position.

The first aerosol-generating article may be configured to provide a first user experience. The second aerosol-generating article may be configured to provide a second user experience. The first user experience may be different to the second user experience. Power may be provided to the first induction coil or first resistive heating element to provide the first experience. A first heating profile may be provided to the first induction coil or first resistive heating element. The first heating profile may be adapted to the characteristics of the first aerosol-generating article. Power may be provided to the second induction coil or the second resistive heating element to provide the second experience. A second heating profile may be provided to the second induction coil or second resistive heating element. The second heating profile may be adapted to the characteristics of the aerosol-generating article.

A third user experience may be provided by providing power to both the first induction coil and the second induction coil. A third user experience may be provided by providing power to both the first resistive heating element and the second resistive heating element. The third user experience may be a combination of the first user experience and the second user experience. The third user experience may be tuned by adapting one or both of the first heating profile and the second heating profile. The third user experience may be adapted to the individual preferences of the consumer.

The first heating profile may be adapted to the characteristics of the first aerosol-forming substrate. The second heating profile may be adapted to the characteristics of the second-forming substrate.

The first heating profile may be adapted to the characteristics of the first aerosol-generating article. The second heating profile may be adapted to the characteristics of the second aerosol-generating article.

The shape of the first aerosol-generating article may be different to the shape of the second aerosol-generating article.

By providing differently shaped first article and second article, the user may readily distinguish between the first article and the second article. By providing differently shaped articles and correspondingly matching first cavity and second cavity, the risk of the consumer inserting the first article into the second cavity or inserting the second article into the first cavity may be reduced.

The first aerosol-forming substrate may form part of the first aerosol-generating article. The second aerosol-forming substrate may form part of the second aerosol-generating article. The first aerosol-generating article may be shaped to closely conform to the shape of the first cavity. The second aerosol-generating article may be shaped to closely conform to the shape of the second cavity.

An airflow through the first cavity may at least partially flow through an inserted first aerosol-generating article. An airflow through the first cavity may at least partially flow through an inserted first aerosol-forming substrate.

An airflow through the second cavity may at least partially flow through an inserted second aerosol-generating article. An airflow through the second cavity may at least partially flow through an inserted second aerosol-forming substrate.

The device may comprise a controller. The first induction coil may be connected to the controller. The second induction coil may be connected to the controller. The controller may be configured to control the first induction coil. The controller may be configured to control the second induction coil. The controller may be configured to control the first induction coil independently from the second induction coil. The controller may be configured to control a first power supply to the first induction coil. The controller may be configured to control a second power supply to the second induction coil. The first power supply may be different to the second power supply. The first power supply may be different to the second power supply in terms of one or more of intensity and timing. The controller may be configured to provide a first heating profile to the first induction coil. The controller may be configured to provide a second heating profile to the second induction coil.

The controller may be configured to provide power to the first resistive heating element. The controller may be configured to provide power to the second resistive heating element. The controller may be configured to provide power to the first resistive heating element independently from providing power to the second heating element. The power provided to the first resistive heating element may be different to the power provided to the second resistive heating element. The controller may be configured to provide a first heating profile to the first resistive heating element. The controller may be configured to provide a second heating profile to the second resistive heating element. The first heating profile may be different to the second heating profile.

The controller may be configured to operate the third inlet valve. The controller may be configured to adjust the air flow through the first airflow channel inlet. The controller may be connected to the electromagnets arranged at the proximal end of the first airflow channel inlet. The controller may be configured to supply power to the electromagnets. The controller may be configured to adjust the magnetic field of the electromagnets. The controller may be configured to adjust the interaction strength between the electromagnets and the first inlet valve. The controller may be configured to control the strength of the magnetic field of the electromagnet by supplying power to the electromagnet.

The controller may be configured to operate the fourth inlet valve. The controller may be configured to adjust the air flow through the second airflow channel inlet. The controller may be connected to the electromagnets arranged at the proximal end of the second airflow channel inlet. The controller may be configured to supply power to the electromagnets. The controller may be configured to adjust the magnetic field of the electromagnets. The controller may be configured to adjust the interaction strength between the electromagnets and the fourth inlet valve. The controller may be configured to control the strength of the magnetic field of the electromagnet by supplying power to the electromagnet.

The invention allows the user to flexibly adapt the user experience. For example, the user may insert a first aerosol-generating article comprising a first aerosol-forming substrate having particular first characteristics, such as first flavour or a first nicotine content, if a user experience having such first characteristic is desired. Alternatively, the user may insert a second aerosol-generating article comprising a second aerosol-forming substrate having particular second characteristics, such as second flavour or a second nicotine content, if the user experience having such second characteristics is desired. Alternatively, if the user desires a combination of the first characteristics and the second characteristics, the user may insert both the first aerosol-generating article and the second aerosol-generating article. The ratio between the first characteristics and the second characteristics may be adjusted by adapting the heating profile of the first heating element and the second heating element. For example, if a user experience having predominantly the first characteristic is desired, one or both of the intensity of the power supply and the length of this power supply to the first induction coil or the first resistive heating element may be increased, while one or both of the intensity of the power supply and the length of the power supply to the second induction coil or the second resistive heating element may be decreased.

One or both of the first inlet valve and the second inlet valve may improve the convenience of usage for the user. One or both of the first inlet valve and the second inlet valve may help with removing a used aerosol-generating article from the device by ejecting the used article when the mouthpiece is removed from the device.

The third inlet valve and fourth inlet valve may allow improvement of the air and aerosol flow through the device and improvement of the user experience. The third inlet valve may be used to adjust the characteristics of the airflow through the first airflow channel. The fourth inlet valve may be used to adjust the characteristics of the airflow through the second airflow channel. Such characteristics may be the speed or volume of the airflow. The characteristics of the airflow may influence the properties of the aerosol formed. For example, if an increased airflow through first airflow channel is desired, the third inlet valve may be opened or may be further opened. If decrease of the airflow through the first airflow channels desired, the third inlet valve may be closed or further closed.

The valves of the invention may improve the flexibility of the user experience. The valves allow the user to regulate the airflow through the device in dependence of the presence of an inserted aerosol-generating article. Insertion of the aerosol-generating article into the device may open the valve of the corresponding cavity to allow an airflow through such cavity and aerosol-generating article. Volatized aerosol-forming substrate of the aerosol-generating article may be carried with such airflow through at least a portion of the device. If no aerosol-generating article is present in a specific cavity, then the corresponding cavity inlet valve is closed by default, such that airflow from the air inlet through the corresponding cavity is blocked.

If the user chooses to insert a first aerosol generating article, airflow through the first cavity and the first aerosol-generating article is achieved as the insertion of the first aerosol-generating article opens the valve of the first cavity. Additionally, if the user refrains from inserting an aerosol-generating article into the second cavity, the second inlet valve is closed, such that airflow from the air inlet through the second cavity is blocked. Dilution of the aerosol may be reduced. Unfavourable airflow through the empty second cavity may be avoided.

If the user, in contrast, chooses to insert additionally a second aerosol-generating article to the second cavity, the second inlet valve is opened by the presence of the inserted second aerosol-generating article, such that airflow through the second cavity and the second aerosol-generating article is allowed.

In use, the consumer may insert one or both of the first aerosol-generating article and the second aerosol-generating article into the device depending on the individual user experience desired. The user may mount the mouthpiece to the device. The inlet valves of the cavities in which an article is inserted are opened by the corresponding article pushing on the corresponding inlet valve. The inlet valves of the cavities in which no article is inserted are closed by the biasing means. The user may draw on the mouthpiece to pull in air through the air inlet of the device. The airflow may flow through the cavities comprising inserted articles via the opened cavity inlets. The airflow may not flow through the cavities not comprising inserted articles as the corresponding cavity inlets are closed. The electronically operated valves of one or both of the first airflow channel the second airflow channel may be adjusted in dependence on the desired user experience. The heating elements in contact with the inserted articles may heat the aerosol-forming substrates of such articles to volatize at least a portion of such substrates. The heating profiles delivered by the heating elements may be independently adapted taking into account the characteristics of article heated by the corresponding heating elements. A portion of the volatized substrate may flow directly into the chamber of the mouthpiece via the open end of the corresponding cavity. A portion of the volatized substrate may flow into an airflow channel abutting the heating element. Such portion of volatized aerosol-forming substrate may mix with an airflow entering the corresponding airflow channel through the airflow channel inlet, depending on if or how much the inlet valve of that airflow channel is opened. The mixture may enter the chamber of the mouthpiece through the open end of the corresponding airflow channel. The different airflows into the chamber of the mouthpiece may mix in chamber of the mouthpiece. Such mixture may cool to produce an aerosol. The aerosol may be inhaled by the user through the mouthpiece.

A longitudinal axis of a component may be an axis along or parallel to the lengthwise direction of the component. A longitudinal axis of the device may extend between the distal end and the proximal end of the device. A longitudinal axis of the article may extend between the distal end and the proximal end of the article.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

A “proximal direction” may refer to the direction of a longitudinal axis of the aerosol-generating device extending from an end of the aerosol-generating device opposite to a mouth end of the device towards the mouth end of the device.

The aerosol-generating device may comprise a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply and a heating arrangement.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of the controller. The electric circuitry may comprise further electronic components. The electric circuitry may be configured to regulate a supply of power to the heating arrangement. Power may be supplied to the heating arrangement continuously following activation of the aerosol-generating device or may be supplied intermittently, such as on a puff-by-puff basis. The power may be supplied to the heating arrangement in the form of pulses of electrical current. The electric circuitry may be configured to monitor the electrical resistance of one or both of the first heating element and the second heating element, and preferably to control the supply of power to one or both of the first heating element and the second heating element dependent on the electrical resistance of the first heating element and the second heating element.

The aerosol-generating device may comprise a power supply, typically a battery, within the main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. The power supply may be a Lithium-ion polymer battery. As an alternative, the power supply may be another form of charge storage device such as a capacitor. The power supply may be a super-capacitor. The power supply may be a hyper-capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The first cavity may be configured as a heating chamber. The second cavity may be configured as a heating chamber. The first cavity may have a hollow rectangular shape. The second cavity may have a hollow rectangular shape. The first cavity may have a shape corresponding to the shape of the first aerosol-generating article to be received in the first cavity. The second cavity may have a shape corresponding to the shape of the second aerosol-generating article to be received in the second cavity. The first cavity may have an inner diameter corresponding to the outer diameter of the first aerosol-generating article. The second cavity may have an inner diameter corresponding to the outer diameter of the second aerosol-generating article.

The heating arrangement may be a resistive heating arrangement. One above of the first heating element and the second heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating arrangement may be an induction heating arrangement. The induction heating arrangement may comprise the first induction coil and the first induction heating element. The induction heating arrangement may comprise the second induction coil and the second induction heating element. The induction heating arrangement may comprise the first induction coil, the second induction coil, the first induction heating element and the second induction heating element.

One or both of the first heating element and the second heating element may be a susceptor. One both of the first heating element and the second heating element may be a material that is capable of generating heat, when penetrated by an alternating magnetic field. The first induction coil may generate an alternating magnetic field in the first cavity. The first induction coil may generate an alternating magnetic field penetrating the first heating element. The second induction coil may generate an alternating magnetic field in the second cavity. The second induction coil may generate an alternating magnetic field penetrating the second heating element.

If one or both of the first heating element and the second heating element is conductive, then typically eddy currents are induced by the alternating magnetic field. If one or both of the first heating element and the second heating element is magnetic, then typically another effect that contributes to the heating is commonly referred to hysteresis losses. Hysteresis losses occur mainly due to the movement of the magnetic domain blocks within the one or both of first heating element and the second heating element, because the magnetic orientation of these will align with the magnetic induction field, which alternates. Another effect contributing to the hysteresis loss is when the magnetic domains will grow or shrink within the one or both of the first heating element at the second heating element. Commonly all these changes in the one or both of the first heating element and the second heating element that happen on a nano-scale or below are referred to as “hysteresis losses”, because they produce heat in the one or both of the first heating element and the second heating element. Hence, if the one or both of the first heating element and the second heating element is both magnetic and electrically conductive, both hysteresis losses and the generation of eddy currents will contribute to the heating of the one or both of the first heating element and the second heating element. If the one or both of the first heating element and the second heating element is magnetic, but not conductive, then hysteresis losses will be the only means by which the one or both of the first heating element and the second heating element will heat, when penetrated by an alternating magnetic field. According to the invention, the one or both of the first heating element and the second heating element may be electrically conductive or magnetic or both electrically conductive and magnetic. An alternating magnetic field generated by the first induction coil may heat the first heating element, which then transfers the heat to the first aerosol-forming substrate. An alternating magnetic field generated by the second induction coil may heat the second heating element, which then transfers the heat to the second aerosol-forming substrate. The heat transfer may be mainly by conduction of heat. Such a transfer of heat is best, if the one above of the first heating element and the second heating element is in close thermal contact with the aerosol-forming substrate.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise nicotine. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol. The aerosol-forming substrate may be a liquid aerosol-forming substrate. The aerosol-forming substrate may comprise flavouring. The aerosol-forming substrate may comprise botanicals. The aerosol-forming substrate may comprise cannabis for therapeutic use.

The invention is defined in the claims. However, below there is provided a non-exhaustive list of non-limiting examples. Any one or more of the features of these examples may be combined with any one or more features of another example, embodiment, or aspect described herein.

Example 1: An aerosol-generating device comprising a first cavity configured for receiving a first aerosol-generating article comprising a first aerosol-forming substrate, a second cavity configured for receiving a second aerosol-generating article comprising a second aerosol-forming substrate, an air inlet, a first cavity inlet arranged between the air inlet and the first cavity, a first inlet valve, wherein the first inlet valve is configured to be movable between a closed position and an open position, wherein, in the closed position, the air inlet and the first cavity are fluidly disconnected, and, wherein, in the open position, the first cavity is fluidly connected with the air inlet via the first cavity inlet, wherein the first inlet valve comprises a first biasing means configured for biasing the first inlet valve towards the closed position in the absence of the first aerosol-generating article being fully inserted into the first cavity, wherein the first inlet valve is configured to be in the open position when the first aerosol-forming element is fully inserted in the first cavity, a second cavity inlet arranged between the air inlet and the second cavity, a second inlet valve, wherein the second inlet valve is configured to be movable between a closed position and an open position, wherein, in the closed position, the air inlet and the second cavity are fluidly disconnected, and, wherein, in the open position, the second cavity is fluidly connected with the air inlet via the second cavity inlet, wherein the second inlet valve comprises a second biasing means configured for biasing the second inlet valve towards the closed position in the absence of the second aerosol-generating article being fully inserted into the second cavity, wherein the second inlet valve is configured to be in the open position when the second aerosol-forming element is fully inserted in the second cavity.

Example 2: The aerosol-generating device according to example 1, wherein the first inlet valve is at least partially arranged within the first cavity inlet, and wherein the second inlet valve is at least partially arranged within the second cavity inlet.

Example 3: The aerosol-generating device according to any of the preceding examples, wherein the device comprises a first airflow channel, and wherein the device comprises a first airflow channel inlet arranged between the air inlet and the first airflow channel, preferably wherein the first airflow channel is planar.

Example 4: The aerosol-generating device according to example 3, wherein the device comprises a third inlet valve configured for adjusting an airflow between the air inlet and the first airflow channel via the first airflow channel inlet.

Example 5: The aerosol-generating device according to example 4, wherein the third inlet valve is configured to be movable between a closed position and an open position, wherein, in the closed position, the air inlet and the first airflow channel are fluidly disconnected, and, wherein, in the open position, the first airflow channel is fluidly connected with the air inlet via the first airflow channel inlet.

Example 6: The aerosol-generating device according to any of examples 4 and 5, wherein the third inlet valve is at least partially arranged within the first airflow channel inlet.

Example 7: The aerosol-generating device according to any of examples 4 to 6, wherein the third inlet valve is an electronically controlled valve.

Example 8: The aerosol-generating device according to example 7, wherein the device comprises at least one electromagnet arranged at a proximal end of the first airflow channel inlet, wherein the device is configured such that the airflow between the air inlet and the first airflow channel via the first airflow channel inlet is adjusted by controlling a magnetic interaction between the electromagnet and the third inlet valve.

Example 9: The aerosol-generating device according to any of the preceding examples, wherein one or more of the first biasing means, the second biasing means and the third inlet valve comprises a spring, preferably a coil spring.

Example 10: The aerosol-generating device according to any of the preceding examples, wherein one or both, the first biasing means is arranged proximal to the first cavity inlet and the second biasing means is arranged proximal to the second cavity inlet.

Example 11: The aerosol-generating device according to any of the preceding examples, wherein one or both of the first inlet valve and the second inlet valve is configured as a spring valve.

Example 12: The aerosol-generating device according to any of the preceding examples, wherein one or more of the first inlet valve, the second inlet valve and the third inlet valve comprises a spring retaining means preferably configured as a disc, a head preferably configured as a tapered head, and a shaft, wherein the shaft is arranged between the spring retaining means and the head.

Example 13: The aerosol-generating device according to example 12, wherein the biasing means, preferably the spring is configured abutting the spring retaining means.

Example 14: The aerosol-generating device according to any of the preceding examples, wherein one or more of the first inlet valve, the second inlet valve and the third inlet valve comprises a valve guide, preferably wherein the shaft of the valve is arranged at

Example 15: The aerosol-generating device according to any of the preceding examples, wherein the device comprises a heating arrangement, wherein the heating arrangement comprises a first heating element and a second heating element, wherein the first heating element is configured abutting the first cavity, and wherein the second heating element is configured abutting the second cavity, preferably wherein one or both of the first heating element and the second heating element is planar.

Example 16: The aerosol-generating device according to example 15, wherein one or both of the first heating element and the second heating element each comprise one or more perforations.

Example 17: The aerosol-generating device according to any of examples 15 and 16, wherein the first heating element is arranged between the first cavity and the first airflow channel, wherein the second heating element is arranged between the second cavity and the first airflow channel, wherein the first heating element is arranged abutting the first airflow channel, and wherein the second heating element is arranged abutting the first airflow channel.

Example 18: The aerosol-generating device according to example 17, wherein the first heating element is configured for fluidly connecting the first cavity with the first airflow channel via the one or more perforations of the first heating element, and wherein the second heating element is configured for fluidly connecting the second cavity with the first airflow channel via the one or more perforations of the second heating element.

Example 19: The aerosol-generating device according to any of examples 1 to 16, wherein the device comprises a second airflow channel, wherein the device comprises a second airflow channel inlet arranged between the air inlet and the second airflow channel, preferably wherein the second airflow channel is planar.

Example 20: The aerosol-generating device according to example 19, wherein the device comprises a fourth inlet valve configured for adjusting an airflow between the air inlet and the second airflow channel via the second airflow channel inlet.

Example 21: The aerosol-generating device according to example 20, wherein the fourth inlet valve is configured to be movable between a closed position and an open position, wherein, in the closed position, the air inlet and the second airflow channel are fluidly disconnected, and, wherein, in the open position, the second airflow channel is fluidly connected with the air inlet via the second airflow channel inlet.

Example 22: The aerosol-generating device according to any of examples 20 and 21, wherein the fourth inlet valve is at least partially arranged within the second airflow channel inlet.

Example 23: The aerosol-generating device according to any of examples 20 to 22, wherein the fourth inlet valve is an electronically controlled valve.

Example 24: The aerosol-generating device according to example 23, wherein the device comprises at least one electromagnet arranged at a proximal end of the second airflow channel inlet, wherein the device is configured such that the airflow between the air inlet and the second airflow channel via the second airflow channel inlet is adjusted by controlling a magnetic interaction between the electromagnet and the third inlet valve.

Example 25: The aerosol-generating device according to any of examples 19 to 24, wherein the first heating element is configured abutting the first airflow channel, wherein the second heating element is configured abutting the second airflow channel, wherein the first heating element is configured for fluidly connecting the first cavity with the first airflow channel via the one or more perforations of the first heating element, and wherein the second heating element is configured for fluidly connecting the second cavity with the second airflow channel via the one or more perforations of the second heating element.

Example 26: The aerosol-generating device according to any of examples 15 to 25, wherein the heating arrangement comprises a first induction coil, preferably a first planar induction coil.

Example 27: The aerosol-generating device according to example 26, wherein the first induction coil is arranged abutting the first cavity and the second cavity.

Example 28: The aerosol-generating device according to any of examples 26 and 27, wherein the heating arrangement comprises a second induction coil, preferably a second planar induction coil.

Example 29: The aerosol-generating device according to example 28, wherein the first induction coil is arranged abutting the first cavity, and wherein the second induction coil is arranged abutting the second cavity.

Example 30: The aerosol-generating device according to any of the preceding examples, wherein the device comprises a removable mouthpiece.

Example 31: The aerosol-generating device according to any of the preceding examples, wherein the device comprises a main body comprising one or more of a controller and a power supply.

Example 32: The aerosol-generating device according to any of the preceding examples, wherein the first biasing means is configured for exerting an ejecting force in a proximal direction on the first aerosol-generating article.

Example 33: The aerosol-generating device according to any of the preceding examples, wherein the second biasing means is configured for exerting an ejecting force in a proximal direction on the second aerosol-generating article.

Example 34: The aerosol-generating device according to any of examples 30 to 33, wherein the mouthpiece is configured for exerting a force in a distal direction on the first aerosol-generating article inserted into the first cavity against the bias of the first biasing means, such that the first inlet valve is moved from the closed position to the open position.

Example 35: The aerosol-generating device according to any of examples 30 and 34, wherein the mouthpiece is configured for exerting a force in a distal direction on the second aerosol-generating article inserted into the second cavity against the bias of the second biasing means, such that the second inlet valve is moved from the closed position into the open position.

Example 36: The aerosol-generating device according to any of the preceding examples, wherein one or both of the first cavity and the second cavity is planar.

Example 37: An aerosol-generating system comprising the aerosol-generating device according to any of examples 1 to 36, wherein the system comprises a first aerosol-generating article comprising a first aerosol-forming substrate, preferably a first planar aerosol-generating article.

Example 38: The aerosol-generating system according to example 37, wherein one or both of the first aerosol-generating article and the first aerosol-forming substrate is porous.

Example 39: The aerosol-generating system according to any of examples 37 and 38, wherein the system comprises a second aerosol-generating article comprising a second aerosol-forming substrate, preferably a second planar aerosol-generating article.

Example 40: The aerosol-generating system according to example 39, wherein one or both of the second aerosol-generating article and the second aerosol-forming substrate is porous.

Example 41: The aerosol-generating system according to any of examples 37 to 40, wherein the first aerosol-forming substrate is configured to be different from the second aerosol-forming substrate.

Example 42: The aerosol-generating system according to any of examples 37 to 40, wherein the first aerosol-forming substrate is configured to be the same as the second aerosol-forming substrate.

Example 43: The aerosol-generating system according to any of examples 34 to 42, wherein the first aerosol-generating article is shaped to closely conform to the shape of the first cavity and wherein the second aerosol-generating article is shaped to closely conform to the shape of the second cavity.

Example 44: The aerosol-generating system according to any of example 34 to 43, wherein one or both of the first aerosol-forming substrate and the first aerosol-generating article is configured to move the first inlet valve from the closed position into the open position.

Example 45: The aerosol-generating system according to any of examples 39 to 44, wherein one or both of the second aerosol-forming substrate and the second aerosol-generating article is configured to move the second inlet valve from the closed position into the open position.

Below, there is provided a non-exhaustive list of non-limiting examples. Any one or more of the features of these examples may be combined with any one or more features of another example, embodiment, or aspect described herein.

Features described in relation to one embodiment may equally be applied to other embodiments of the invention.

The invention will be further described, by way of example only, with reference to the accompanying drawings in which:

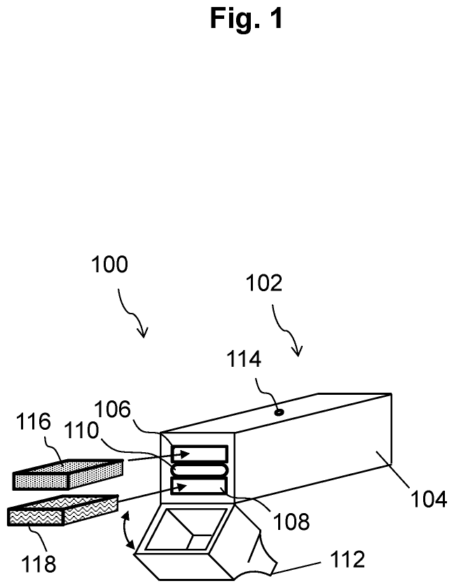

FIG. 1 shows an aerosol-generating system of the invention;

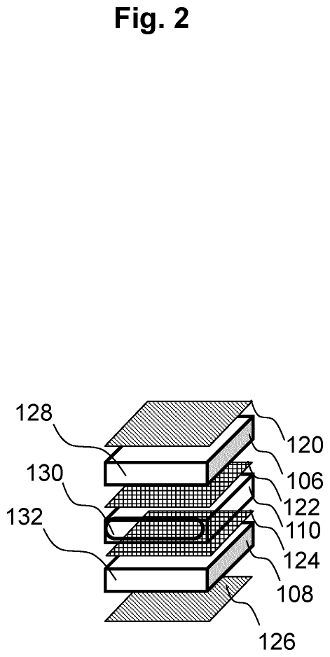

FIG. 2 shows a layered view of components of the aerosol-generating system of the invention;

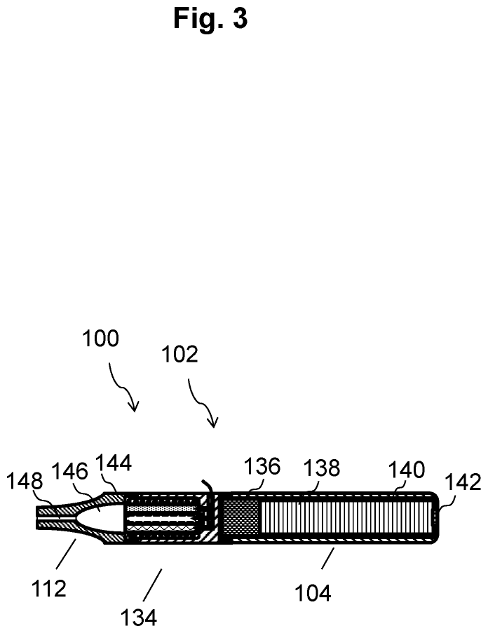

FIG. 3 shows the aerosol-generating system of the invention;

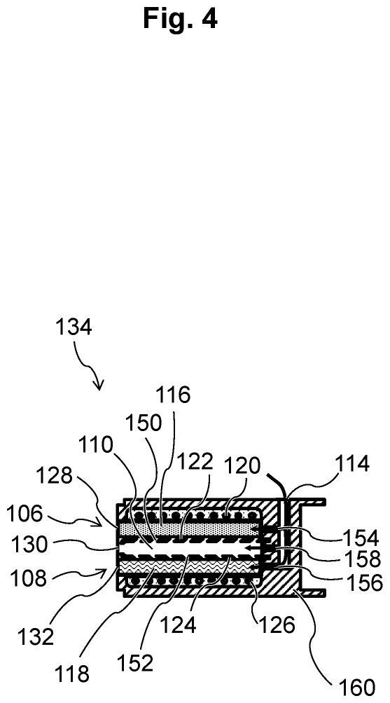

FIG. 4 shows the details of the intermediate section of FIG. 3;

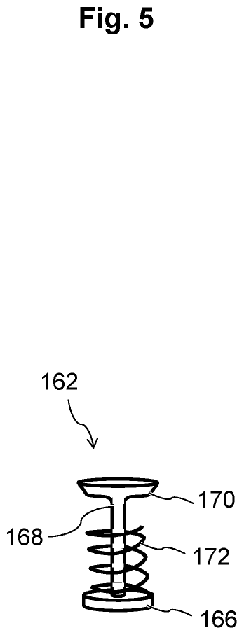

FIG. 5 shows an inlet valve of the invention;

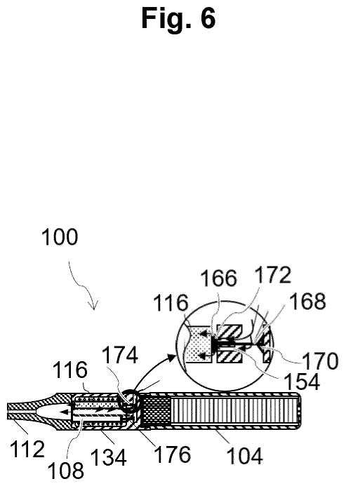

FIG. 6 shows the aerosol-generating system of the invention;

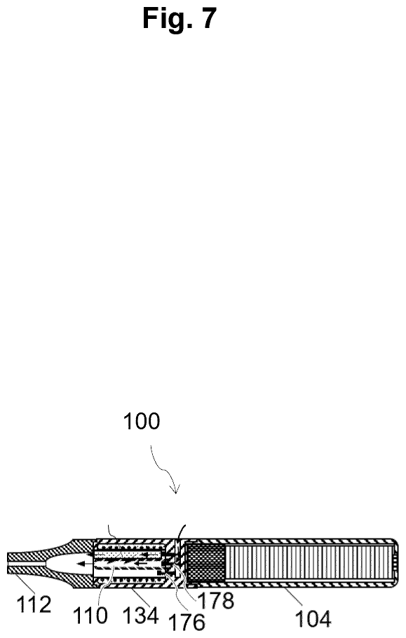

FIG. 7 shows the aerosol-generating system of the invention;

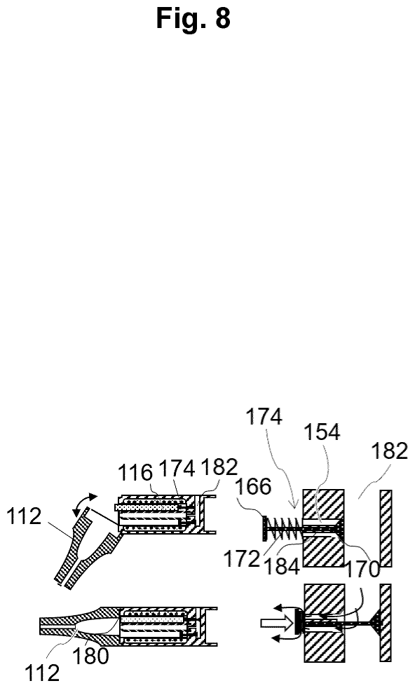

FIG. 8 illustrates the interplay between the mouthpiece and the intermediate section in the control of the inlet valves;

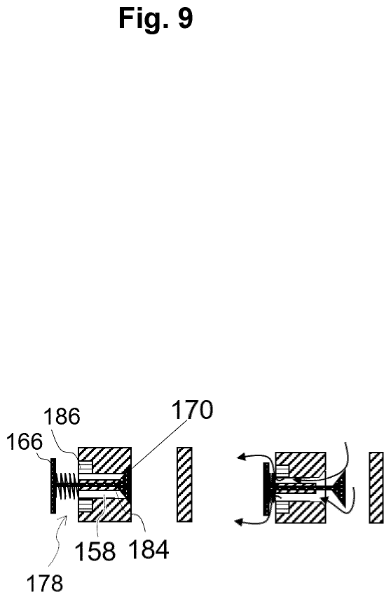

FIG. 9 shows a third inlet valve;

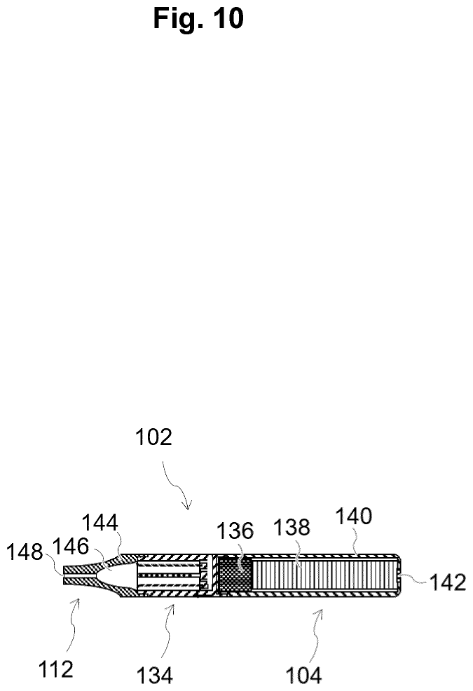

FIG. 10 shows an aerosol-generating device of the invention;

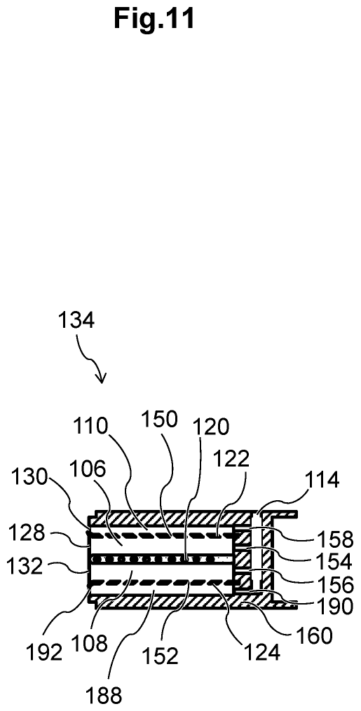

FIG. 11 shows the intermediate section of the device of FIG. 10;

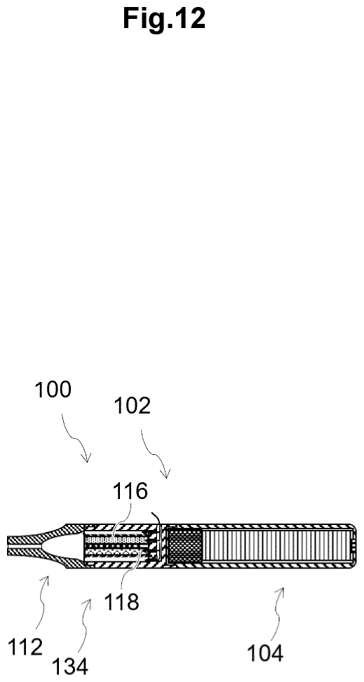

FIG. 12 shows an aerosol-generating system comprising the aerosol-generating device of FIG. 11 into which a first aerosol-generating article and a second aerosol-generating article are inserted;

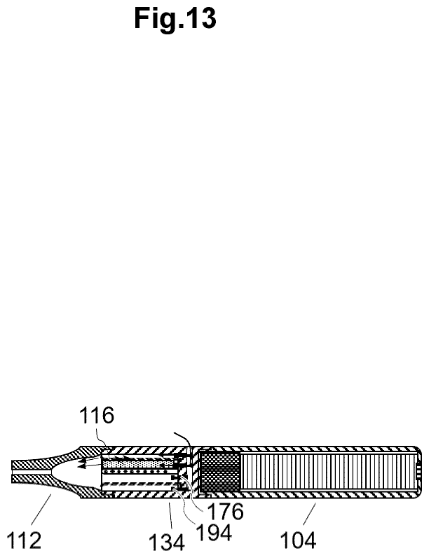

FIG. 13 shows an aerosol-generating system comprising the aerosol-generating device of FIG. 11 into which a first aerosol-generating article 116 is inserted.

FIG. 1 shows a simplified illustration of an aerosol-generating system 100. The system comprises an aerosol-generating device 102. The device comprises a main body 104. The device comprises a first cavity 106. The device comprises a second cavity 108. The device comprises a first airflow channel 110. The device comprises a mouthpiece 112. The device comprises an air inlet 114.

First cavity 106 abuts first airflow channel 110. Second cavity 108 abuts first airflow channel 110. First airflow channel 110 is arranged between first cavity 106 and second cavity 108.

The system 100 comprises a first aerosol-generating article 116 comprising a first aerosol forming substrate. The system comprises a second aerosol-generating article 118 comprising a second aerosol-forming substrate. First aerosol-generating article 116 may be different to second aerosol-generating article 118. For example, first aerosol-generating article 116 may comprise a different aerosol-forming substrate than second aerosol-generating article 118. First aerosol-generating article 116 may be inserted into first cavity 106 is indicated by an arrow. Second aerosol-generating article 118 may be inserted into second cavity 108 as indicated by an arrow.

Mouthpiece 112 is a hinged mouthpiece. Mouthpiece 112 may be moved between a first position and a second position. FIG. 1 shows the first position of mouthpiece 112, in which mouthpiece 112 is arranged to allow aerosol-generating articles to be inserted into the device 102. Once one or both of first aerosol-generating article 116 and second aerosol-generating article 118 are inserted into device 102, mouthpiece 112 may be moved into the second position in which mouthpiece 112 engages with the downstream end of aerosol-generating device 102.

In the second position, mouthpiece 112 abuts the downstream end of main body 104 of the device. In the second position, mouthpiece 112 is in fluid communication with first cavity 106, second cavity 108, and first airflow channel 110.

Device 102 comprises a first heating element and a second heating element (not shown)

In use, the user may draw on mouthpiece 112 to draw air into air inlet 114. The drawn air may be distributed between first cavity 106, second cavity 108, and airflow channel 110. The airflow through first cavity 106 may at least partially enter first aerosol-generating article 116. The airflow through the second cavity 108 may at least partially enter second aerosol-generating article 118. The first heating element may heat the inserted first aerosol-forming substrate. The first heating element may at least partially volatize the first aerosol-forming substrate. Additionally or alternatively, the second heating element may heat the inserted second aerosol-forming substrate. The second heating element may at least partially volatize the inserted second aerosol-forming substrate.

Volatized first aerosol-forming substrate may flow radially inward into the first airflow channel 110. Volatized first aerosol-forming substrate may directly flow into mouthpiece 112. Volatized second aerosol-forming substrate may flow radially inward into the first airflow channel 110. Volatized second aerosol-forming substrate may directly flow into mouthpiece 112. Volatized first aerosol-forming substrate and volatized second-aerosol forming substrate mix in first airflow channel 110 with air directly drawn into first airflow channel 110 through air inlet 114. Such mixture may flow from first airflow channel 110 into mouthpiece 112. Aerosol may be inhaled through mouthpiece 112.

FIG. 2 shows a staggered view of an arrangement of components of the invention. The components form a stack which may be included in an intermediate section or main body 104 of aerosol-generating device 112. The stack comprises, from top to bottom, a first planar induction coil 120, first planar cavity 106, a planar first perforated induction heating element 122, first planar airflow channel 110, a planar second perforated induction heating element 124, second planar cavity 108 and a second planar induction coil 126.

First cavity 106 comprises an open end 128. Airflow channel 110 comprises an open end 130. Second cavity 108 comprises an open end 132. First cavity 106 may be fluidly connected with mouthpiece 112 via open end 128 of first cavity 106. Second cavity 108 may be fluidly connected with mouthpiece 112 via open end 132 of second cavity 108. First airflow channel 110 may be fluidly connected with mouthpiece 112 via open end 130 of the first airflow channel 110.

FIG. 3 shows the aerosol-generating system 100 of the invention. The system comprises device 102. Device 102 comprises main body 104. Device 102 comprises mouthpiece 112. Device 102 comprises an intermediate section 134.

Main body 104 comprises a controller 136. Main body 104 comprises a power supply 138. Controller 136 may be configured to supply intermediate section 134 with power from power supply 138. Main body 104 comprises a housing 140. Main body 104 comprises an interface 142 which may be a data port or an interface for connecting an external energy source to recharge power supply 138.

Mouthpiece 112 comprises a housing 144. Mouthpiece 112 comprises a chamber 146. Mouthpiece 112 comprises an aerosol outlet 148.

Aerosol-generating device 102 is shown to be assembled. Main body 104 is removably mounted to an upstream end of intermediate section 134. Intermediate section 134 is removably mounted to an upstream end of mouthpiece 112. The details of the intermediate section 134 are shown in FIG. 4.

FIG. 4 shows the details of the intermediate section 134 of FIG. 3. Intermediate section 134 comprises first planar heating coil 120. Intermediate section 134 comprises second planar heating coil 126. Intermediate section 134 comprises first planar cavity 106. Intermediate section 134 comprises second planar cavity 108. Intermediate section 134 comprises first planar heating element 122. First planar heating element 122 is an induction heating element. Intermediate section 134 comprises second planar heating element 124. Second planar heating element 124 is an induction heating element. Intermediate section

First heating element 122 comprises angled perforations 150. Second heating element 124 comprises angled perforations 152.

First cavity 106 comprises open end 128. Second cavity 108 comprises open end 132. First airflow channel 110 comprises open end 130.

Intermediate section 134 comprises air inlet 114. Intermediate section 134 comprises a first cavity inlet 154. Intermediate section 134 comprises a second cavity inlet 156. Intermediate section 134 comprises a first airflow channel inlet 158. Intermediate section 134 comprises housing 160. Air inlet 114 may be arranged in housing 160. Intermediate section 134 comprises a first inlet valve (not shown), second inlet valve (not shown) and a third inlet valve (not shown). The first inlet valve, second inlet valve and third inlet valve are in an open position.

First aerosol-generating article 116 is shown to be inserted into first cavity 106. Second aerosol-generating article 118 is shown to be inserted into second cavity 108.

In use, the user may draw on aerosol outlet 148 of mouthpiece 112, such that air enters air inlet 114. The airflow through air inlet 114 may be distributed between the first cavity inlet 154, the second cavity inlet 156, and the first airflow channel inlet 158.

The airflow through first cavity inlet 160 enters first cavity 106. The airflow through second cavity inlet 162 enters second cavity 108. The airflow through first air flow channel inlet 164 enters first airflow channel 110.

At least a portion of the airflow flows through at least a portion of first aerosol-generating article 116. At least a portion of the airflow flows through at least a portion of the second aerosol-generating article 118.

First induction coil 120 may heat first heating element 122. Second induction coil 122 may heat second heating element 124. First heating element 122 is in contact with first aerosol-generating article 116. Second heating element 124 is in contact with second aerosol-generating article 118. First heating element 122 heats the first aerosol-forming substrate to volatize at least a portion of the first aerosol-forming substrate. Second heating element 122 heats the second aerosol-forming substrate to volatize at least a portion of the second aerosol-forming substrate. The heating profile delivered by first heating element 122 and second heating element 124 may be independently adjusted taking into account the characteristics of the articles and the desired user experience.

At least a portion of the airflow through one or both of first cavity 106 and first aerosol-generating article 116 enters first airflow channel 110 via perforations 150. At least a portion of the airflow through one or both of second cavity 108 and second aerosol-generating article 118 enters first airflow channel 110 by perforations 152.

At least a portion of the volatized first aerosol-forming substrate may enter mouthpiece 112 through open end 128. At least a portion of the volatized second aerosol-forming substrate may enter mouthpiece 112 through open end 132.

Volatized first aerosol-forming substrate flowing from first cavity 106 into first airflow channel 110 via perforations 150 and volatized second aerosol-forming substrate flowing from second cavity 108 into first airflow channel 110 by perforations 152 mix with the airflow entering first airflow channel 110 via first airflow channel inlet 158. Such mixture flows into mouthpiece 112 through open end 130.

The airflow from the first cavity via open end 128, the airflow from second cavity 108 via open end 132 and the airflow from first airflow channel 110 via open end 130 mix in chamber 146 of mouthpiece 112. The mixture of such airflows is cooled in chamber 146 to form an aerosol. The user may inhale the aerosol through aerosol outlet 148.

FIG. 5 shows an inlet valve 162 of the invention. Inlet valve 162 is configured as a spring valve. Inlet valve 162 comprises a spring retaining means 166. Spring retaining means 166 is a disc. Inlet valve 162 comprises a shaft 168. Shaft 168 comprises a rod. Inlet valve 162 comprises a head 170. Head 170 is tapered. Head 170 is connected to shaft 168. Shaft 168 is connected to spring retaining means 166.

Inlet valve 162 comprises a biasing element 172. Biasing element 172 is a coil spring. Coil spring 172 is arranged around shaft 168. Coil spring 172 is in contact with spring retaining element 166.

FIG. 6 shows system 100 of the invention. The above remarks relating to system 100 of FIG. 3 apply, mutatis mutandis, to system 100 of FIG. 6. However, system 100 of FIG. 6, contains only first aerosol-generating article 116 inserted into first cavity 106. No aerosol-generating article is inserted into second cavity 108. FIG. 6 shows a first inlet valve 174 and a second inlet valve 176. First inlet valve 174 and second inlet valve 176 are configured as the inlet valve 162 shown in FIG. 5.

The round inset of FIG. 6 shows a more detailed view of first inlet valve 174 and first cavity inlet 154.

First inlet valve 174 is at least partially arranged in first cavity inlet 154. Second inlet valve 176 is at least partially arranged in second cavity inlet 156.

First inlet valve 174 is shown in an open position. Inserted first aerosol-generating article 116 holds first inlet valve 174 in the open position. Inserted first aerosol-generating article 116 pushes against first spring retaining means 166 of first inlet valve 174 to compress spring 172. Head 170 is arranged separate from first cavity inlet 154. Inserted first aerosol-generating article pushes head 170 away from first cavity inlet 154. As indicated by the arrows, air flows from air inlet 114 through first cavity inlet 154 into first cavity 106. As discussed above, a portion of the airflow entering first cavity 106 flows into first airflow channel 110 through perforations 150. At least a portion of the airflow entering first cavity 106 flows into chamber 146 through open end 128. The airflow through first airflow channel 110 flows into mouthpiece 112 via open end 130.

Second inlet valve 176 is in a closed position. The biasing means in the form of a spring of second inlet valve 176 pushes against the spring retaining means to keep second inlet valve 176 in the closed position. Second cavity inlet 156 is blocked by head 170 of second inlet valve 176. Air inlet 114 is fluidly disconnected from second cavity inlet 156. There is no airflow from air inlet 114 to second cavity 108 via second cavity inlet 156.

FIG. 7 shows system 100 of the invention. The above remarks relating to system 100 of FIG. 6 apply, mutatis mutandis, to system 100 of FIG. 7. FIG. 7 further shows a third inlet valve 178. Third inlet valve 178 is arranged at least partially in first airflow channel inlet 158. Third inlet valve 178 is shown to be in an open position. An airflow may flow from air inlet 114 through first airflow channel inlet 158 into first airflow channel 110. The airflow entering first airflow channel 110 through first airflow channel inlet 158 mixes with volatized first aerosol-forming substrate entering first airflow channel 110 through perforations 150. Such mixture flows into chamber 146 of mouthpiece 112. Third inlet valve 178 may be an electronically controlled valve. The controller may be configured to adjust t third inlet valve 178. The controller may adjust the airflow through first airflow channel 110 by controlling the position of the third inlet valve 178 with respect to the first airflow channel inlet 158.

FIG. 8 shows the interplay between mouthpiece 112 and intermediate section 134 in the control of the inlet valves. The above remarks regarding mouthpiece 112 and intermediate section 134 equally apply to mouthpiece 112 and intermediate section 134 of FIG. 8.

On the top left, mouthpiece 112 is shown in a first position. In the first position, the mouthpiece is at least partially removed from the proximal end of intermediate section 134. On the top right, a more detailed illustration of the corresponding first inlet valve 174 is shown.

On the bottom left, mouthpiece 112 is shown in a second position. In the second position, mouthpiece 112 abuts the proximal end of intermediate section 134. On the bottom right, a more detailed illustration of the corresponding first inlet valve 174 is shown.

Mouthpiece 112 of FIG. 8 is a hinged mouthpiece. As indicated by the double-headed arrow on the top left drawing, mouthpiece 112 may be swiveled between the first position and the second position.

In the top left drawing, first aerosol-generating article 116 is partially inserted into first cavity 106. First aerosol-generating article 116 is in contact with first inlet valve 174. First inlet valve 174 is in a closed position. Head 170 is in contact with first cavity inlet 154. Head 170 blocks airflow from air inlet 114 into first cavity inlet 154.

When mouthpiece 112 is mounted to the upstream end of intermediate section 134, pushing means 180 pushes the partially inserted first aerosol-generating article 116 towards the distal end of the device. First aerosol-generating article 116 engages with first spring retaining means 166. First inlet valve 174 is pushed towards the distal end of the device. Head 170 disengages from first cavity inlet 154. First cavity 106 is then fluidly connected to air inlet 114 via opened first cavity inlet 154. First cavity 106 is fluidly connected to an air distribution channel 182.

As no aerosol-generating article is inserted in second cavity 108, second inlet valve 178 is in a closed position.

First inlet valve 174 comprises a valve guide 184. Shaft 168 is partially arranged in valve guide 184. Valve guide 184 may precisely position first inlet valve 174 in first cavity inlet 154. Valve guide 184 may improve the accuracy of fluidly disconnecting air inlet 114 from first cavity inlet 154.

FIG. 9 shows third inlet valve 178 partially inserted into first airflow channel inlet 158. The configuration of third inlet valve 178 corresponds to the configuration shown in FIG. 5. Third inlet valve 178 comprises valve guide 184.

Electromagnets 186 are arranged at the downstream end of first airflow inlet 158. Electromagnets 186 are arranged at the base of first airflow channel 110.

On the left-hand side, third inlet valve 178 is shown in a closed position. On the right-hand side third inlet valve 178 is shown in an open position. Third inlet valve 178 may be moved from the closed position into the opposition by electromagnets 186.

The controller is connected to electromagnets 186. The controller may apply power to electromagnets 186 to create a magnetic field. The magnetic field may attract spring retaining means 166. When power is provided to electromagnets 186, they exert a magnetic force on spring retaining means 166 in a distal direction. Spring retaining means 166 may move in a distal direction. Head 170 moves away from the distal end of first airflow inlet 158, such that air inlet 114 is fluidly connected to first airflow channel 110.

FIG. 10 shows an aerosol generating device 102 of the invention. The remarks relating to device 102 of system 100 of FIG. 3 apply, mutatis mutandis, to the device of FIG. 10. The details of intermediate section 134 as shown in more detail in FIG. 11.

FIG. 11 shows the intermediate section 134 of the device of FIG. 10. Intermediate section 134 comprises first induction coil 120. First induction coil 120 is centrally arranged on a central longitudinal axis of the device. First cavity 106 abuts first induction coil 120. Second cavity 108 abuts first induction coil 120. First cavity 106 and second cavity 108 sandwich first induction coil 120. First induction coil 120 is arranged between first cavity 106 and second cavity 108.

Intermediate section 134 comprises first heating element 122. Intermediate section 134 comprises second heating element 124. Intermediate section 134 comprises first airflow channel 110. Intermediate section 134 comprises a second airflow channel 188. First heating element 122 is arranged between first airflow channel 110 and first cavity 106. Second heating element 124 is arranged between second airflow channel 188 and second cavity 108.

Intermediate section 134 comprises first cavity inlet 154. Intermediate section 134 comprises second cavity inlet 156. Intermediate section 134 comprises first airflow channel inlet 158. Intermediate section 134 comprises a second airflow channel inlet 190.

Intermediate section 134 comprises air inlet 114.

Intermediate section 134 comprises first cavity open end 128. Intermediate section 134 comprises second cavity open end 132. Intermediate section 134 comprises first airflow channel open end 130. Intermediate section 134 comprises second airflow channel open end 192.

First cavity open end 128 is fluidly connected to chamber 146 of mouthpiece 112. Second cavity open end 132 is fluidly connected to chamber 146. First airflow channel open end 130 is fluidly connected to chamber 146. Second airflow channel open end 192 is fluidly connected to chamber 146.

First inlet valve 174 (not shown) is arranged at least partially in first cavity inlet 154. Second inlet valve 176 (not shown) is arranged at least partially in second cavity inlet 156. Third inlet valve 178 (not shown) is arranged at least partially in first airflow channel inlet 158. Fourth inlet valve 194 (not shown) is arranged at least partially in second airflow channel inlet 190.

First inlet valve 174 controls airflow into first cavity 106 via first cavity inlet 154. Second inlet valve 176 controls airflow into second cavity 108 via second cavity inlet 156. Third inlet valve 178 controls airflow into first airflow channel 110 via first airflow channel inlet 158. Fourth inlet valve 194 controls airflow into second airflow channel 188 via second airflow channel inlet 190.

FIG. 12 shows aerosol-generating system 100 comprising an aerosol-generating device 102 of FIG. 11 into which first aerosol-generating article 116 and second aerosol-generating article 118 are inserted. First aerosol-generating article 116 is inserted into first cavity 106. Second aerosol-generating article 118 is inserted into second cavity 108.

First inlet valve 174, second inlet valve 176, third inlet valve 178, and fourth inlet valve 194 are all in an open position. At least a portion of the airflow entering air inlet 114 flows through first cavity inlet 154 into first cavity 106. At least a portion of the airflow entering air inlet 114 flows through second cavity inlet 156 into second cavity 108. At least a portion of the airflow entering air inlet 114 flows through first airflow channel inlet 158 into first airflow channel 110. At least a portion of the airflow entering air inlet 114 flows through second airflow channel inlet 190 into second airflow channel 188.

Induction heating coil 120 may heat first heating element 122. Induction heating coil 120 may heat second heating element 124. First heating element 122 may heat the first aerosol-forming substrate of first aerosol-generating article 116 to volatize at least a portion of the first aerosol-forming substrate. Second heating element 124 may heat the second aerosol-forming substrate of second aerosol-generating article 116 to volatize at least a portion of the second aerosol-forming substrate.

At least a portion of the volatized first aerosol-forming substrate may flow from first cavity 106 into first airflow channel 110 via perforations 150. At least a portion of the volatized second aerosol-forming substrate may flow from second cavity 108 into second airflow channel 188 via perforations 152.

At least a portion of the volatized first aerosol-forming substrate may flow from first cavity 106 into mouthpiece 112 via first cavity open end 128. At least a portion of the volatized second aerosol-forming substrate may flow from second cavity 108 into mouthpiece 112 via second cavity open end 132.

Volatized first aerosol-forming substrate entering first airflow channel 110 via perforations 150 mixes with the airflow entering first airflow channel 110 via first airflow channel inlet 154. Such mixture flows into mouthpiece 112 via first airflow open end 130.

Volatized second aerosol-forming substrate entering second airflow channel 188 via perforations 152 mixes with the airflow entering second airflow channel 188 via first airflow channel inlet 190. Such mixture flows into mouthpiece 112 via second airflow channel open end 192.

The airflow is from the first cavity 106, second cavity 108, first airflow channel 110 and second airflow channel 188 mix in chamber 146 of mouthpiece 112. Such mixture cools in chamber 146 to form an aerosol. The user may inhale the aerosol via aerosol outlet 148.

FIG. 13 shows aerosol-generating system 100 comprising an aerosol-generating device 102 of FIG. 11 into which the first aerosol-generating article 116 is inserted. No second aerosol-generating article is inserted into second cavity 108.

Second inlet valve 176 is in a closed position as no second aerosol-generating articles inserted into second cavity 108. Second cavity 108 is fluidly disconnected from air inlet 114. Fourth inlet valve 194 is in a closed position. Second airflow channel 188 is fluidly disconnected from air inlet 114.

First induction coil 120 heats first heating element 122. First heating element 122 heats first aerosol-forming substrate of first aerosol-generating article 116 to volatize at least a portion of the first aerosol-forming substrate. At least a portion of the volatized first aerosol-forming substrate flows from first cavity 106 into first airflow channel 110 via perforations 150. Such portion of volatized first aerosol-forming substrate mixes with the airflow entering first airflow channel 110 via first airflow channel inlet 158. Such mixture flows from first airflow channel 110 into mouthpiece 112 via first airflow channel open end 130.

At least a portion of the volatized first aerosol-forming substrate flows from first cavity 106 into mouthpiece 112 via first cavity open end 128.

The airflows from the first cavity 106 and first airflow channel 110 mix in chamber 146 of mouthpiece 112. Such mixture cools in chamber 146 to form an aerosol. The user may inhale the aerosol via aerosol outlet 148.

1.-15. (canceled)

16. An aerosol-generating device, comprising:
a first cavity configured to receive a first aerosol-generating article comprising a first aerosol-forming substrate;
a second cavity configured to receive a second aerosol-generating article comprising a second aerosol-forming substrate;
an air inlet;
a first cavity inlet arranged between the air inlet and the first cavity;
a first inlet valve configured to be movable between a closed position and an open position, wherein, in the closed position, the air inlet and the first cavity are fluidly disconnected, wherein, in the open position, the first cavity is fluidly connected with the air inlet via the first cavity inlet, wherein the first inlet valve comprises a first biasing means configured to bias the first inlet valve towards the closed position in the absence of the first aerosol-generating article being fully inserted into the first cavity, and wherein the first inlet valve is configured to be in the open position when the first aerosol-generating article is fully inserted in the first cavity;
a second cavity inlet arranged between the air inlet and the second cavity;
a second inlet valve configured to be movable between a closed position and an open position, wherein, in the closed position, the air inlet and the second cavity are fluidly disconnected, wherein, in the open position, the second cavity is fluidly connected with the air inlet via the second cavity inlet, wherein the second inlet valve comprises a second biasing means configured for biasing the second inlet valve towards the closed position in the absence of the second aerosol-generating article being fully inserted into the second cavity, and wherein the second inlet valve is configured to be in the open position when the second aerosol-generating article is fully inserted in the second cavity; and
a heating arrangement comprising a first heating element and a second heating element,
wherein the first heating element is arranged abutting the first cavity, and
wherein the second heating element is arranged abutting the second cavity.

17. The aerosol-generating device according to claim 16,
wherein the first inlet valve is at least partially arranged within the first cavity inlet, and
wherein the second inlet valve is at least partially arranged within the second cavity inlet.

18. The aerosol-generating device according to claim 16, further comprising:
a first airflow channel; and
a first airflow channel inlet arranged between the air inlet and the first airflow channel.

19. The aerosol-generating device according to claim 18, wherein the first airflow channel is planar.

20. The aerosol-generating device according to claim 18, further comprising a third inlet valve configured to adjust an airflow between the air inlet and the first airflow channel via the first airflow channel inlet.

21. The aerosol-generating device according to claim 20,
wherein the third inlet valve is configured to be movable between a closed position and an open position,
wherein, in the closed position, the air inlet and the first airflow channel are fluidly disconnected, and,
wherein, in the open position, the first airflow channel is fluidly connected with the air inlet via the first airflow channel inlet,

22. The aerosol-generating device according to claim 20, wherein the third inlet valve is at least partially arranged within the first airflow channel inlet.

23. The aerosol-generating device according to claim 20, wherein the third inlet valve is an electronically controlled valve.

24. The aerosol-generating device according to claim 16, wherein one or more of the first biasing means, the second biasing means, and the third inlet valve comprises a spring.

25. The aerosol-generating device according to claim 16, wherein one or more of the first biasing means, the second biasing means, and the third inlet valve comprises a coil spring.

26. The aerosol-generating device according to claim 16, wherein one or both of the first heating element and the second heating element is planar.

27. The aerosol-generating device according to claim 16,
wherein the first heating element is arranged between the first cavity and the first airflow channel,
wherein the second heating element is arranged between the second cavity and the first airflow channel,
wherein the first heating element is arranged abutting the first airflow channel, and
wherein the second heating element is arranged abutting the first airflow channel.

28. The aerosol-generating device according to claim 16,
wherein the heating arrangement comprises a first induction coil, and
wherein the heating arrangement comprises a second induction coil.

29. The aerosol-generating device according to claim 28,
wherein the first induction coil is a first planar induction coil, and
wherein the second induction coil is a second planar induction coil.

30. The aerosol-generating device according to claim 16,
wherein the first biasing means is configured to exert an ejecting force in a proximal direction on the first aerosol-generating article, and
wherein the second biasing means is configured to exert an ejecting force in a proximal direction on the second aerosol-generating article.

31. An aerosol-generating system comprising the aerosol-generating device according to claim 16 and a first aerosol-generating article comprising a first aerosol-forming substrate, preferably a first planar aerosol-generating article.

32. The aerosol-generating system according to claim 31, wherein the first aerosol-forming article is a first planar aerosol-generating article.

33. The aerosol-generating system according to claim 31, further comprising a second aerosol-generating article comprising a second aerosol-forming substrate.

34. The aerosol-generating system according to claim 33, wherein the second aerosol-generating article is a second planar aerosol-generating article.

35. The aerosol-generating system according to claim 33,
wherein one or both of the first aerosol-forming substrate and the first aerosol-generating article is configured to move the first inlet valve from the closed position into the open position, and
wherein one or both of the second aerosol-forming substrate and the second aerosol-generating article is configured to move the second inlet valve from the closed position into the open position.
